(19) United States
(12) Patent Application Publication
(10) Pub. No.: US 2007/0009010 A1
(43) Pub. Date: Jan. 11, 2007

(54) Wafer temperature measuring method and apparatus

(76) Inventors: Koji Shio, Hiratsuka-shi (JP); Hideyuki Wakai, Hiratsuka-shi (JP); Akihiro Ohsawa, Hiratsuka-shi (JP); Hironori Akiba, Hiratsuka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/472,463

(22) Filed: Jun. 22, 2006

(30) Foreign Application Priority Data
Jun. 23, 2005 (JP) 2005-183295
Jun. 29, 2005 (JP) 2005-189570
Jun. 29, 2005 (JP) 2005-189825

(51) Int. Cl. G01K 11/00

(52) U.S. Cl. 374/161

(57) ABSTRACT

A non-contact wafer temperature measuring apparatus by which a wafer temperature can be measured with accuracy in situ even in a low temperature process. The wafer temperature measuring apparatus for measuring a wafer temperature based on reflected light of light applied to a wafer as a target of temperature measurement includes: a light source unit for generating light containing a P-polarized component having a wavelength not larger than 400 nm and applying the light to the wafer; a light receiving unit for receiving the light reflected by the wafer and detecting at least intensity of the P-polarized component having the wavelength not larger than 400 nm; and a signal processing unit for calculating a temperature of the target of temperature measurement at least based on the intensity of the P-polarized component having the wavelength not larger than 400 nm detected by the light receiving unit.

### BACKGROUND OF THE INVENTION

1. Field of the Invention

The present invention relates to a wafer temperature measuring method and a wafer temperature measuring apparatus to be used for controlling a wafer temperature in semiconductor manufacturing processes.

2. Description of a Related Art

Recent years, with miniaturization of semiconductor devices, accurate wafer temperature control has become increasingly important in semiconductor manufacturing processes.

Currently, a method using a radiation thermometer is in the main stream of wafer temperature measuring methods. In the measuring method, a temperature is measured by detecting thermal radiation emitted from a target of temperature measurement, and therefore, the temperature can be measured without contact with a wafer. According to the measuring method, a temperature can be measured with high accuracy in a range not less than about 300° C., and the method is adopted in high temperature processes at about 800° C. to about 1000° C. However, in the measuring method, there is a problem of accelerated reduction in accuracy as the temperature of the target becomes lower. For example, a temperature can hardly be measured when the target is at 200° C. or less. The reason is that it becomes hard to detect thermal radiation from a silicon semiconductor because the peak in wavelength of the thermal radiation is in the infrared region at a lower temperature and the silicon semiconductor is transparent in the region.

Accordingly, in the present circumstances, a wafer temperature is measured by disposing the temperature sensor near a wafer as a target of temperature measurement in low temperature processes at about 100° C. to about 200° C. However, in the measuring method, there is a problem that a temperature can not be measured with high accuracy due to the contact thermal resistance. For example, in a liquid or solid, since the liquid or solid serves to conduct heat, accuracy to some degree can be maintained even when the contact between the wafer as the target of temperature measurement and the temperature sensor is in a somewhat bad condition. However, such heat conduction does not occur in the air or vacuum, and the contact heat resistance becomes extremely large. Further, the contact heat resistance differs from wafer to wafer, which contributes to increasing errors.

Various other studies on wafer temperature measuring methods have been made. Features and problems of the currently studied wafer temperature measuring methods will be described as follows:

(1) Method Using Infrared Transmittance Measurement

A silicon semiconductor steeply becomes transparent to light having a wavelength near about 1.1 μm. Such a wavelength range in the absorption property is referred to as “absorption edge”. Since the absorption edge changes according to the temperature, a wafer temperature can be measured by observing the infrared transmittance and detecting the absorption edge. However, the wavelength of the absorption edge depends not only on a temperature but also on other factors such as impurity concentration contained in the silicon semiconductor. Accordingly, the method is not very practical in the semiconductor manufacturing process through which silicon semiconductors having various impurity concentrations pass. Further, resist films are applied onto wafers and other materials are deposited thereon in the normal semiconductor manufacturing process, and the absorption edge can not be detected correctly when the other material films are deposited on the wafer.

(2) Method Using Reflectance Measurement

Reflectance of a material changes according to the temperature. Accordingly, a wafer temperature can be measured by applying light having known intensity to a wafer, detecting the reflection light thereof, and calculating reflectance. J. Heller et al., “Temperature dependence of the reflectivity of silicon with surface oxide at wavelengths of 633 and 1047 nm”, Applied Physics Letters, July 1999, Vol. 75, No. 1, pp. 43-45 discloses a method of measuring a temperature based on the change of the reflectivity of silicon. However, in such a wafer temperature measuring method, the change of reflectance according to a temperature is very small and a problem arises that measurement with high accuracy is difficult.

In order to mend the problem, Japanese Patent Application Publication JP-P2001-4452A discloses a temperature measuring method including a measuring step of measuring reflectances to light in plural wavelengths on the surface of a target of temperature measurement, a step of obtaining a ratio of the reflectances measured at the measuring step, and a step of identifying the temperature of the target based on the obtained reflectances. Further, JP-P2001-4452A also discloses that light having wavelengths from 430 nm to 800 nm is used for the measurement (page 2). However, it is difficult to improve the accuracy because the change in reflectance according to temperature remains about 10⁻⁵/° C. even using the light having plural wavelengths and the temperature coefficient is still small.

(3) Method Using Spectrum Peak Position Measurement

The peak position of reflection light spectrum changes according to temperature of a material as a reflector. Further, in a silicon semiconductor, peaks of reflection light spectrum appear at wavelengths in the ultraviolet region corresponding to direct transition levels E1 and E2. Accordingly, a wafer temperature can be measured by observing the reflection light spectrum and detecting peak positions. In the measuring method, polarization properties of ultraviolet light that is highly dependent on a temperature are used and, when the accuracy of the spectrum analyzer to be used is high, accurate temperature measurement can be performed. However, such a spectrum analyzer is expensive and the cost rise is problematic.

As a related technology, Japanese Patent Application Publication JP-P2000-2597A discloses an apparatus for processing a silicon work piece for controlling the temperature of the work piece in a manufacturing process of silicon devices. The apparatus includes a work piece support, a light source for applying a beam of polarized light containing ultraviolet light onto the work piece, a spectrum analyzing unit for receiving the beam reflected from the work piece, and a computer for receiving information representing the spectrum of the reflected beam from the spectrum analyzing unit and evaluating the temperature of the work piece from the information.

Further, Japanese Patent Application Publication JP-P2000-356554A discloses a method of measuring a temperature of a silicon work piece for correctly measuring the temperature of the silicon work piece within a wide range containing low temperature. The method includes the steps of (a) providing a conversion system for converting spectrum data into temperature values and (b) measuring the temperature of the silicon work piece by using a light reflective thermometer, and the step (b) includes the steps of (i) directing a polarized beam containing ultraviolet light toward the work piece such that the ultraviolet light is reflected from the work piece to a spectrum analyzer, (ii) acquiring spectrum data by analyzing a spectrum of light reflected from the work piece by using the spectrum analyzer, and (iii) converting the spectrum data into temperature values by using the conversion system.

By the way, generally, an oxide film is naturally formed on the surface of a silicon wafer. Further, sometimes oxide films having various thicknesses are formed on the silicon wafers in the semiconductor manufacturing process. However, in the case where the wafer temperature is measured based on the reflection light from the wafer, when the oxide film is formed on the surface of the wafer, the following problem arises. That is, when light is applied to the wafer, the light is reflected from the oxide film surface or multiple reflections occurs between the oxide film surface and the silicon surface, and thereby, the reflection intensity changes due to interference of light. Variations in reflection intensity caused by such undesirable reflection are sensitive to the thickness of the oxide film and different depending on properties such as kinds of wafers, and thus, the wafer temperature can not be measured correctly.

### SUMMARY OF THE INVENTION

The present invention has been achieved in view of the above-mentioned problems. A purpose of the present invention is to provide a non-contact wafer temperature measuring method by which a wafer temperature can be measured with accuracy in situ even in a low temperature process and to provide a wafer temperature measuring apparatus using the method.

In order to achieve the purpose, a wafer temperature measuring method according to one aspect of the present invention includes the steps of: (a) generating light containing a P-polarized component having a wavelength not larger than 400 nm and applying the light to a wafer as a target of temperature measurement; (b) receiving the light reflected by the target of temperature measurement and detecting at least intensity of the P-polarized component having the wavelength not larger than 400 nm contained in the reflected light; and (c) calculating a temperature of the target of temperature measurement at least based on the intensity of the P-polarized component having the wavelength not larger than 400 nm detected at step (b).

Further, a wafer temperature measuring apparatus according to one aspect of the present invention includes: light applying means for generating light containing a P-polarized component having a wavelength not larger than 400 nm and applying the light to a wafer as a target of temperature measurement; light receiving means for receiving the light reflected by the target of temperature measurement and detecting at least intensity of the P-polarized component having the wavelength not larger than 400 nm contained in the reflected light; and calculating means for calculating a temperature of the target of temperature measurement at least based on the intensity of the P-polarized component having the wavelength not larger than 400 nm detected by the light receiving means.

According to the present invention, the P-polarized component having the wavelength not larger than 400 nm is detected from among the light reflected by the target of temperature measurement and the temperature of the target of measurement is calculated based on the intensity thereof. In the reflection intensity of the P-polarized component of ultraviolet light, the dependence on temperature is significantly great compared to that of S-polarized light and visible light. Therefore, the temperature of the target of measurement can be accurately measured without contact.

### BRIEF DESCRIPTION OF THE DRAWINGS

FIG. 1 is a graph showing the rate of change of reflection intensity of a P-polarized component to silicon;

FIG. 2 is a graph showing reflectance of an S-polarized component to a silicon wafer;

FIG. 3 is a graph showing reflectance of a P-polarized component to the silicon wafer;

FIG. 4 is a schematic diagram showing a configuration of a wafer temperature measuring apparatus according to the first embodiment of the present invention;

FIG. 5 is a block diagram for explanation of a function of a signal processing unit shown in FIG. 4;

FIG. 6 is a flowchart showing a method of calibrating parameters in the first embodiment of the present invention;

FIG. 7 is a flowchart showing a method of calculating a temperature in the first embodiment of the present invention;

FIG. 8 is a schematic diagram showing a configuration of a wafer temperature measuring apparatus according to the second embodiment of the present invention;

FIG. 9 is a schematic diagram showing a configuration of a wafer temperature measuring apparatus according to the third embodiment of the present invention;

FIG. 10 is a diagram for explanation of a modified example of the wafer temperature measuring apparatus according to the third embodiment of the present invention;

FIG. 11 is a schematic diagram showing a configuration of a wafer temperature measuring apparatus according to the fourth embodiment of the present invention;

FIG. 12 is a schematic diagram showing a configuration of a wafer temperature measuring apparatus according to the fifth embodiment of the present invention;

FIG. 13 is a schematic diagram showing a configuration of a wafer temperature measuring apparatus according to the sixth embodiment of the present invention;

FIG. 14 is a schematic diagram showing a configuration of a wafer temperature measuring apparatus according to the seventh embodiment of the present invention;

FIG. 15 is a schematic diagram showing a configuration of a wafer temperature measuring apparatus according to the eighth embodiment of the present invention;

FIGS. 16A and 16B are diagrams for explanation of a method of calibrating parameters in the wafer temperature measuring apparatus according to the embodiments of the present invention;

FIG. 17 is a table showing reflectance of a P-polarized component and an S-polarized component to a silicon oxide film;

FIG. 18 is a graph showing incident angle dependence of the reflectance of the P-polarized component and the S-polarized component to the silicon oxide film; and

FIG. 19 is a schematic diagram showing a configuration of a wafer temperature measuring apparatus according to the ninth embodiment.

### DESCRIPTION OF THE PREFERRED EMBODIMENTS

Hereinafter, preferred embodiments of the present invention will be explained in detail by referring to the drawings. The same component elements are assigned with the same reference numerals and the descriptions thereof will be omitted.

First, the principle of a wafer temperature measuring method used in wafer temperature measuring apparatuses according to the first to ninth embodiments of the present invention will be explained.

In the present invention, a wafer temperature is measured by applying ultraviolet light (light having a wavelength of 40 nm or less) containing a P-polarized component to a wafer as a target of temperature measurement and detecting reflection light reflected by the wafer.

Although the attempt to measure the temperature based on the change in reflection intensity of the silicon substrate is made, only the light having a wavelength equal to or larger than that of visible light is generally used. However, as disclosed in G. E. Ellison et al., “Optical functions of silicon between 1.7 and 4.7 eV at elevated temperatures” (Physical Review B, Jun. 15, 1983, Vol. 27, No. 12), it is known that the dielectric function significantly changes according to temperature in the ultraviolet region corresponding to E1 as a direct transition level of silicon. Further, in Sadao Adachi, “Model dielectric constants of Si and Ge” (Physical Review B, Dec. 15, 1988, Vol. 38, No. 18), a computation model of silicon dielectric function is proposed.

The inventors of the present invention sought a method of optically measuring the temperature by focusing attention on characteristics of the silicon dielectric function in the ultraviolet region. Through the computation using the computation model of Adachi, the inventors have found that the P-polarized component of ultraviolet light exhibits significant temperature dependence compared to the S-polarized component of ultraviolet light and visible light.

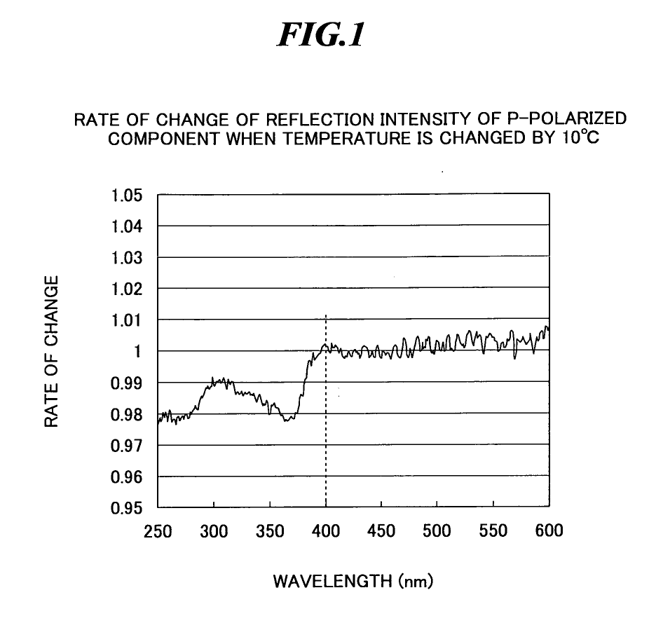

FIG. 1 is a graph showing the rate of change of reflection intensity of a P-polarized component against silicon, which is obtained by applying the P-polarized component to silicon at a predetermined temperature and analyzing wavelength components of the reflected light by using a spectrometer. Here, the rate of change indicated by the vertical axis in FIG. 1 shows a relative value of reflection spectrum intensity after the temperature is elevated by 10° C., given that the reflection spectrum intensity before temperature change is “1”.

As shown in FIG. 1, in the region at wavelengths larger than 400 nm (visible region), the rate of change of reflection intensity remains around “1”, and it is understood that the sensitivity of reflection intensity to the temperature change of a sample (silicon) is not very high. Contrary, in the ultraviolet region at wavelengths less than 400 nm, the rate of change is greatly apart from “1”, and it is understood that the reflection intensity significantly changes according to the temperature change of the sample. In the wavelength regions where the intensity especially greatly changes (wavelength regions where the rate of change is apart from “1”, around 360 nm to 370 nm and near 260 nm within the measurement range), it is found that the reflection intensity changes by 2% or more.

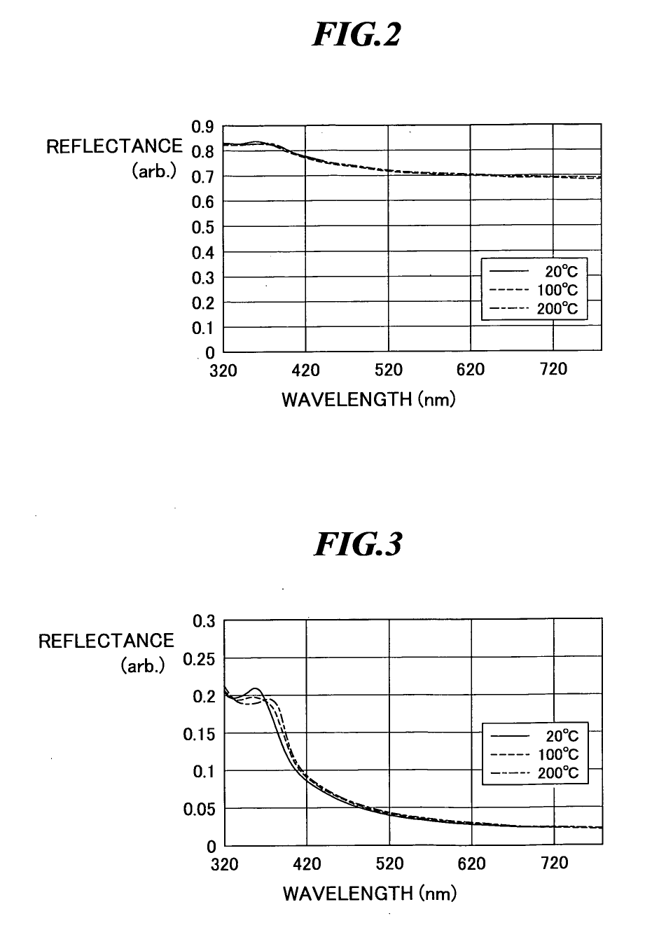

Further, FIG. 2 shows reflectance of an S-polarized component to a silicon wafer, while FIG. 3 shows reflectance of a P-polarized component to the silicon wafer. These graphs are obtained by finding the spectrum intensity of the P-polarized component and the S-polarized component at a predetermined sample temperature by using a model dielectric function (MDF) and temperature characteristics of parameters of the MDF actually measured by spectroscopic ellipsometry. In FIGS. 2 and 3, the solid line shows the change in reflectance when the sample temperature is 20° C., the broken line shows the change in reflectance when the sample temperature is 100° C., and the alternate long and short dash line shows the change in reflectance when the sample temperature is 200° C.

Here, the spectroscopic ellipsometry is a method of evaluating the thickness and refractive index of a thin film based on the ratio of absolute values of the reflectance of the P-polarized component and the reflectance of the S-polarized component and the ratio of phase changes thereof. Further, as to the MDF, refer to Adachi, “Model Dielectric Function (MDF) Theory for Single Crystalline Material”, Journal of Surface Science Society of Japan, Vol. 18, No. 11, pp. 669-675 (1997).

As shown in FIG. 2, regarding the reflectance of the S-polarized component, there is not so much of a difference depending on sample temperature in all wavelength regions. On the other hand, as shown in FIG. 3, regarding the reflectance of the P-polarized component, a difference depending on sample temperature appears in the ultraviolet region. Especially, in the region of 400 nm or less, the reflectance of the P-polarized component greatly changes according to the sample temperature.

Accordingly, the inventors of the present invention have hit on an idea of utilizing the phenomenon that the reflection intensity of the P-polarized component of ultraviolet light is sensitive to the temperature change of the sample, and invented a method and an apparatus for measuring the temperature of a sample by applying light containing a P-polarized component of ultraviolet light to the sample and detecting the P-polarized component of ultraviolet light reflected from the sample.

In the first to ninth embodiments explained as below, ultraviolet light containing a wavelength corresponding to direct transition level E1 or E2 where a peak of reflection light spectrum appears is desirably used for temperature measurement. For example, in the case of silicon, the first peak appears near 370 nm and the second peak appears near 250 nm, and thus, ultraviolet light having a wavelength within a range from substantially 150 nm to substantially 400 nm, desirably a range from substantially 200 nm to substantially 400 nm, more desirably a range from substantially 300 nm to substantially 400 nm is used. Therefore, in the following embodiments, light sources that emit ultraviolet light having a wavelength of about 150 nm to 400 nm such as high-pressure mercury lamps, high-pressure mercury xenon lamps, ultraviolet light emitting diodes (LED) and ultraviolet laser diodes (LD) are used according to apparatus configurations. By the way, the lower limit of the wavelength is determined within a practical range because the device for reception is drastically deteriorated as the wavelength of ultraviolet light becomes shorter and ultraviolet absorption by O₂ occurs at the wavelength of 200 nm or less and the detection accuracy becomes lower.

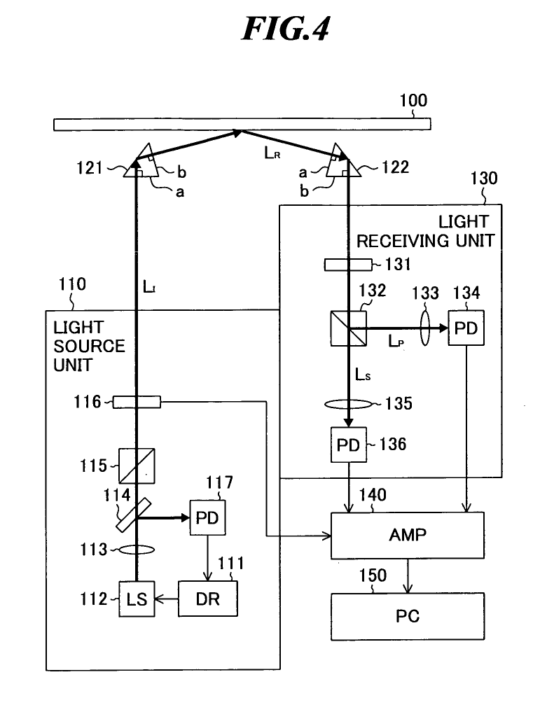

FIG. 4 is a schematic diagram showing a configuration of a wafer temperature measuring apparatus according to the first embodiment of the present invention. The wafer temperature measuring apparatus according to the embodiment is an apparatus for measuring the temperature of a wafer 100 by using a P-polarized component of ultraviolet light as detection light and using, as reference light, an S-polarized component of ultraviolet light having the same wavelength as that of the detection light. Here, in order to improve the detection accuracy of the detection light (P-polarized component) by using a reference light, the S-polarized component of ultraviolet light is used as the reference light because the temperature dependency of the reflection light of the S-polarized component is relatively small.

As shown in FIG. 4, the wafer temperature measuring apparatus according to the embodiment includes a light source unit 110, prisms 121 and 122, a light receiving unit 130, a signal amplifier (AMP) 140 and a signal processing unit 150.

The light source unit 110 includes a drive circuit (DR) 111, a light source (LS) 112, a collimator lens 113, a beam splitter 114, a polarizer 115, an optical chopper 116 and a photodetector (PD) 117, and generates light to be applied to the wafer 100.

The drive circuit 111 controls the operation of the light source 112. Further, the light source 112 is, for example, a light emitting diode (LED) that emits ultraviolet light having a wavelength near 365 nm. The LED is a light source that emits non-polarized light.

The collimator lens 113 forms a parallel beam by transmitting ultraviolet light emitted from the light source 112. The beam splitter 114 transmits and guides a part of incident light to the polarizer 115, and reflects and guides the rest of the incident light to the photodetector 117.

The polarizer 115 transmits and linearly polarizes the ultraviolet light entering via the beam splitter 114. When a light source (e.g., LD) that outputs linearly-polarized light is used, the polarizer 115 may be omitted.

Here, in the embodiment, the P-polarized component and the S-polarized component are used as the detection light and reference light, respectively, and thus, it is desirable that the intensity of the P-polarized component and the intensity of the S-polarized component are nearly equal in the ultraviolet light after reflected by the wafer 100. However, the reflectance of the S-polarized component is about three times larger than the reflectance of the P-polarized component. Accordingly, it is desirable that the polarization direction is adjusted in advance such that the amount of the P-polarized component is larger in the incident light to the wafer 100. Specifically, the angle of the polarizer 115 is adjusted such that the ratio of the P-polarized component to the S-polarized component becomes about 3:1 in the incident light to the wafer 100.

The optical chopper 116 controls timing of ultraviolet light output from the light source unit 110 by chopping the ultraviolet light linearly-polarized by the polarizer 115 with predetermined timing or at a predetermined frequency. Further, the optical chopper 116 outputs an ON/OFF signal to the signal amplifier 140.

The photodetector 117 detects the intensity of the ultraviolet light reflected by the beam splitter 114. An output signal from the photodetector 117 is fed back to the drive circuit 111 and used for light quantity adjustment of the ultraviolet light outputted from the light source 112.

The prism 121 changes the direction of ultraviolet light L_{I} emitted from the light source unit 110 and allows the ultraviolet light L_{I} to be incident upon the wafer 100. Further, the prism 122 changes the direction of ultraviolet light L_{R} reflected by the wafer 100 and guides the ultraviolet light L_{R} to the light receiving unit 130. As the prisms 121 and 122, total reflection prisms in which incident light is totally reflected are used. This is for preventing the change in polarization states such as rotation of the plane of polarization in the light linearly-polarized by the polarizer 115 and the reflection light from the wafer 100. Further, the positions and angles of the prisms 121 and 122 are adjusted such that the entrance plane “a” and the exit plane “b” of the light are perpendicular to the optical axes of incident light and output light, respectively. Thereby, the polarization states of the incident light and output light to and from the prisms 121 and 122 are prevented from changing.

The light receiving unit 130 includes a wavelength selection filter 131, a polarization beam splitter 132, lenses 133 and 135 and photodetectors (PD) 134 and 136, and receives the light reflected by the wafer 100.

The wavelength selection filter 131 is a filter that responds to the light source 112 and selectively transmits wavelength components having wavelengths near 365 nm. By providing the wavelength selection filter 131, the ultraviolet light L_{R} reflected by the wafer 100 and entering via the prism 122 can be allowed to be incident upon the downstream of the light receiving unit 130 and the other light can be cut. As a result, the mixture of unwanted light can be prevented and the detection accuracy can be improved.

The polarization beam splitter 132 is, for example, a Glan laser prism or Wollaston prism, and splits the ultraviolet light L_{R} into a P-polarized component and an S-polarized component by reflecting or transmitting the incident light according to the polarization direction. In FIG. 4, the P-polarized component L_{P} is guided toward the condenser lens 133 and the S-polarized component L_{S} is guided toward the condenser lens 135 by the polarization beam splitter 132.

The condenser lens 133 collects the P-polarized component L_{P} split by the polarization beam splitter 132 and guides it to the photodetector 134. By providing the condenser lens 133, even when the position and direction of the optical path vary to some degree, the influence by the variation can be minimized and the P-polarized component L_{P} can reliably enter the photodetector 134.

The photodetector 134 includes a photoelectric conversion element such as a photodiode (PD), for example, and detects the P-polarized component (detection light) L_{P} collected by the condenser lens 133 to generate an electrical signal according to the light intensity. This electrical signal is outputted as detection signal Y₁ from the light receiving unit 130.

The condenser lens 135 collects the S-polarized component L_{S} split by the polarization beam splitter 132 and guides it to the photodetector 134. The condenser lens 135 is provided for reducing the influence by the variation of the optical path similarly to the condenser lens 133.

The photodetector 136 detects the S-polarized component (reference light) L_{S} collected by the condenser lens 135 to generate an electrical signal according to the light intensity. This electrical signal is outputted as reference signal Y₂ from the light receiving unit 130.

The positional and angular relationships of these prisms 121 and 122, wafer 100 and light receiving unit 130 are adjusted such that the incident angle becomes substantially 35° to substantially 85° when the ultraviolet light L_{I} emitted from the light source unit 110 is incident upon the wafer 100. Here, the incident angle is an angle formed by the normal of the reflection surface of the wafer 100 and the incident light. As the incident angle becomes smaller, the difference between reflectances of the P-polarized component and the S-polarized component becomes smaller, and thus, the measurement accuracy of a temperature is reduced. Contrary, when the incident angle is too large, the anticipated width of the wafer 100 exceeds the beam width of the ultraviolet light L_{I}, and vignetting (a phenomenon that unintended shadows appear) occurs in the ultraviolet light L_{I}. Accordingly, in the embodiment, as a practical range, the incident angle is selected as substantially 35° to substantially 85°, more desirably, substantially 65° to substantially 75°.

The signal amplifier 140 amplifies the detection signal Y₁ and the reference signal Y₂ outputted from the light receiving unit 130 and outputs them to the signal processing unit 150. In this regard, the signal amplifier 140 prevents mixture of signals based on the other light than the detection light L_{P} and the reference light Ls by lock-in operation based on the ON/OFF signal outputted from the optical chopper 116. When there is no possibility of mixture of signals based on the other light than the detection light L_{P} and the reference light L_{S} in the photodetectors 134 and 136, the lock-in operation of the signal amplifier 140 is not required. In this case, the optical chopper 116 is not required.

The signal processing unit 150 controls each unit of the wafer temperature measuring apparatus and calculates the temperature of the wafer 100 based on the detection signal Y₁ and the reference signal Y₂. The signal processing unit 150 may be formed by a personal computer (PC) or formed by employing a microcomputer chip, a digital multimeter, and so on.

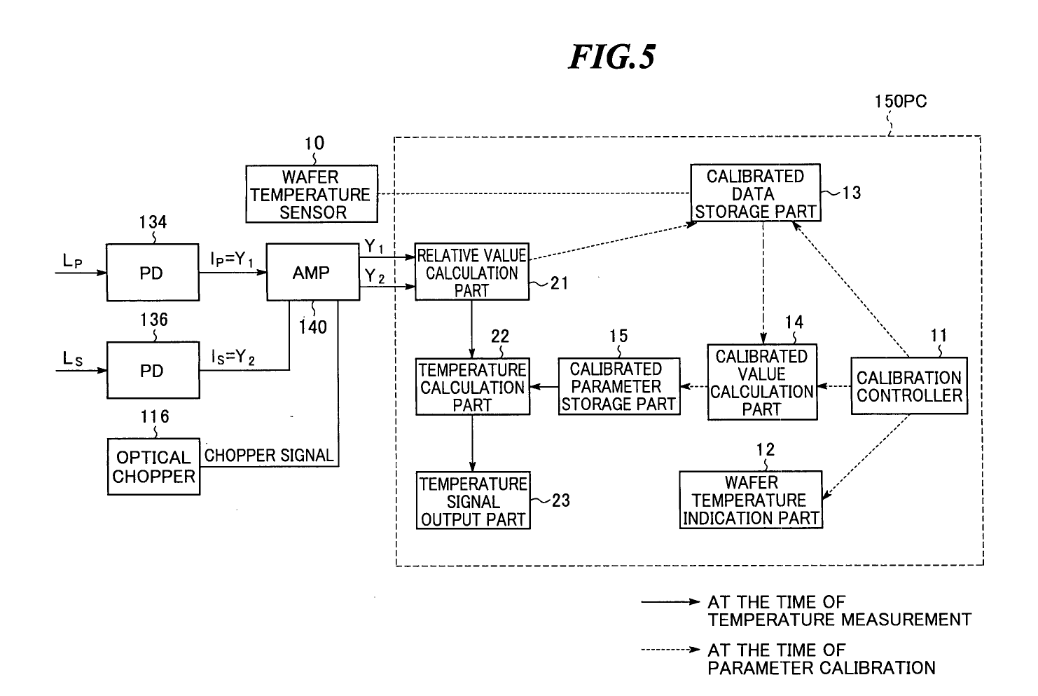

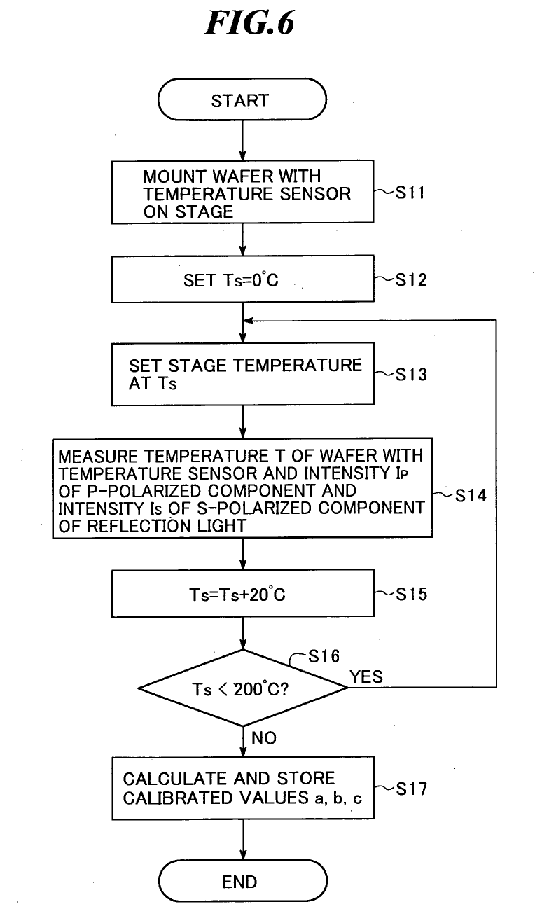

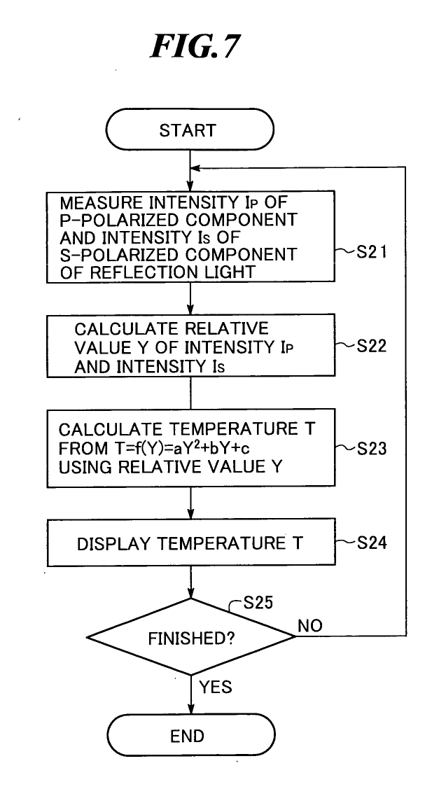

Next, a method of measuring a temperature of the wafer 100 will be explained in detail by referring to FIGS. 5-7. FIG. 5 is a block diagram for explanation of the function of the signal processing unit 150, FIG. 6 is a flowchart showing a method of calibrating parameters, and FIG. 7 is a flowchart showing a method of calculating a temperature.

Here, in the embodiment, the temperature of the wafer 100 is calculated by substituting values obtained based on detection signals representing the intensity of the P-polarized component reflected by the wafer 100 and so on into a predetermined function. For the purpose, parameters of the function to be used are calibrated prior to temperature calculation. This calibration may be carried out at each time the temperature of the wafer 100 is measured or regularly.

Further, the function f(Y) to be used for temperature calculation is a polynomial expression such as f(Y)=aY+b, f(Y)=aY²+bY+c, etc. The function f(Y) is obtained, for example, by detecting detection light and reference light while measuring the temperature of a test wafer by a contact method and performing computation (e.g., regression analysis) by using actual measurement values and detection signal Y₁ and reference signal Y₂ in the wafer temperature measuring apparatus shown in FIG. 4. In the embodiment, the temperature measurement is performed by using the function f (Y)=aY²+bY+c.

As shown in FIG. 5, the signal processing unit 150 has a calibration controller 11, a wafer temperature indication part 12, a calibrated data storage part 13, a calibrated value calculation part 14, a calibrated parameter storage part 15, a relative value calculation part 21, a temperature calculation part 22 and a temperature signal output part 23. In FIG. 5, the broken line shows the flow of operation at the time of parameter calibration, while the solid line shows the flow of information at the time of temperature measurement.

When the parameter calibration is performed, first, at step S11 in FIG. 6, a test wafer with a temperature sensor is set on a stage of the wafer temperature measuring apparatus.

Then, at step S12, the calibration controller 11 (FIG. 5) sets calibration temperature T_{S} to 0° C. In response, at step S13, the wafer temperature indication part 12 sets the stage temperature of the wafer temperature measuring apparatus to T_{S} (=0° C.).

Then, at step S14, the temperature T of the test wafer with the temperature sensor and intensity I_{P} of P-polarized component L_{P} and intensity I_{S} of S-polarized component L_{S} reflected by the wafer are measured. The temperature T of the test wafer with the temperature sensor is stored in the calibrated data storage part 13. Further, the detection signal Y₁ detected by the photodetector 134 and representing the intensity I_{P} of P-polarized component L_{P} is amplified by the signal amplifier 140 and converted into a digital signal, and then, inputted to the relative value calculation part 21. On the other hand, the reference signal Y₂ detected by the photodetector 136 and representing the intensity I_{S} of the S-polarized component L_{S} is amplified by the signal amplifier 140 and converted into a digital signal, and then, inputted to the relative value calculation part 21. The relative value calculation part 21 calculates a relative value Y=Y₁/Y₂ based on the detection signal Y₁ and the reference signal Y₂, and stores them in the calibrated data storage part 13. The relative value Y represents a relative value between the intensity I_{P} of the P-polarized component and the intensity I_{S} of the S-polarized component.

Then, at step S15, the calibration controller 11 calculates a temperature elevated by 20° C. from the calibration temperature T_{S}. If the obtained calibration temperature T_{S} is lower than 200° C., at step S16, the setting of a stage temperature and measurements of temperature T of the test wafer with the temperature sensor, the intensity I_{P} of the P-polarized component and the intensity I_{S} of the S-polarized component are repeated again (steps S13 to S16). On the other hand, if the calibration temperature T_{S} is equal to or higher than 200° C., the calibration controller 11 ends these measurements and starts the calculation of calibrated values of parameters (step S17).

At step S17, the calibrated value calculation part 14 acquires the temperature T of plural wafers stored in the calibrated data storage part 13 and corresponding relative values Y(=Y₁/Y₂), creates plural expressions by substituting those values into function T=f(Y)=aY²+bY+c. Then, parameters a, b, c are obtained by using those expressions in accordance with the least square method. These calibrated parameters are stored in the calibrated parameter storage part 15.

When the wafer temperature is measured, first, at step S21 in FIG. 7, the intensity I_{P} of the P-polarized component L_{P} and the intensity I_{S} of the S-polarized component L_{S} reflected by the wafer 100 (FIG. 4) are measured. The detection signal Y₁ representing the intensity I_{P} of the P-polarized component L_{P} is amplified by the signal amplifier 140 and converted into a digital signal, and then, inputted to the relative value calculation part 21. Further, the reference signal Y₂ representing the intensity I_{S} of the S-polarized component L_{S} is amplified by the signal amplifier 140 and converted into a digital signal, and then, inputted to the relative value calculation part 21.

Then, at step S22, the relative value calculation part 21 calculates relative value Y(=Y₁/Y₂) of the intensity I_{P} of the P-polarized component and the intensity I_{S} of the S-polarized component. At step S23, the temperature calculation part 22 acquires the calibrated parameters a, b, c from the calibrated parameter storage part 15, and calculates the temperature T of the wafer 100 by using the function T=f (Y)=aY²+bY+c and the relative value Y calculated by the relative value calculation part 21.

At step S24, the temperature signal output part 23 outputs a signal representing the calculated temperature T to a monitor or the like and allows it to display the temperature T. Then, if the temperature measurement is further continued (step S25), the intensity I_{P} of the P-polarized component L_{P} and the intensity I_{S} of the S-polarized component L_{S} are measured again.

In the above explanation, the simple ratio Y₁/Y₂ of the detection signal Y₁ to the reference signal Y₂ is used as the relative value Y, however, the ratio of values after removing offsets (Y₁−α)/(Y₂−α) may be used. Further, the relative value may be obtained by using a suitable function. For example, the relative value Y may be obtained from Y=(aY₁²+bY₁+c)/(aY₂²+bY₂+c).

Further, instead of calculating the temperature by using the relative value Y of the detection signal Y₁ and the reference signal Y₂, the temperature may be directly calculated by using function g(Y₁, Y₂) with the detection signal Y₁ and the reference signal Y₂ as variables. This function g(Y₁, Y₂) and parameters thereof may be obtained by using the actual measurement values obtained by the contact method similarly to the case of the function f(Y).

In the above-explained embodiment, the detection light (P-polarized component L_{P}) and the reference light (S-polarized component L_{S}) takes the same optical path until they enter the light receiving unit 130. Accordingly, the variation in optical path caused by the tilt of the wafer 100 as a target of temperature measurement and the influence by the thermal disturbance of gases and so on in the optical path are the same in the detection light and the reference light immediately before split. Therefore, there is an advantage that such an influence can be cancelled by taking the relative value between the detection light and the reference light (e.g., the ratio between them). Thereby, temperature measurement can be performed with higher accuracy than that of the other methods (e.g., a method using reflectance as a ratio of incident light to reflected light to or from the wafer 100).

In the embodiment, when the wafer temperature is simply measured, only the intensity of the detection light (P-polarized component) may be used. In this case, the detection signal Y₁ outputted from the photodetector 134 of the light receiving unit 130 shown in FIG. 4 may be converted into a temperature using a predetermined expression. As described above, the reflection intensity of the P-polarized component of ultraviolet light is sensitive to the temperature change of the sample, and therefore, the wafer temperature can be measured without using the reference light.

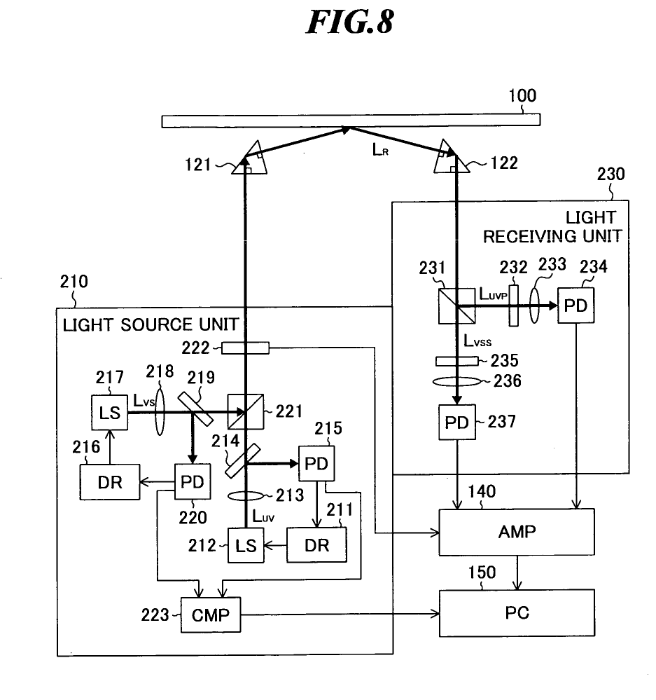

Next, a wafer temperature measuring apparatus according to the second embodiment of the present invention will be explained. FIG. 8 is a schematic diagram showing a configuration of the wafer temperature measuring apparatus according to the embodiment. In the embodiment, a temperature of the wafer 100 is measured by using a P-polarized component of ultraviolet light as detection light and using an S-polarized component having a different wavelength from that of the detection light as reference light. As the reference light, visible light having reflection intensity with relatively low temperature dependence is desirably used.

As shown in FIG. 8, the wafer temperature measuring apparatus according to the embodiment includes a light source unit 210, the prisms 121 and 122, a light receiving unit 230, the signal amplifier 140 and the signal processing unit 150. The configuration and operation of the prisms 121 and 122, the signal amplifier 140 and the signal processing unit 150 are the same as those in the wafer temperature measuring apparatus shown in FIG. 4.

The light source unit 210 includes drive circuits (DR) 211 and 216, light sources (LS) 212 and 217, collimator lenses 213 and 218, beam splitters 214 and 219, photodetectors (PD) 215 and 220, a polarization beam splitter 221, an optical chopper 222 and a light quantity comparison part (CMP) 223.

The drive circuit 211 controls the operation of the light source 212. Further, the light source 212 is, for example, an LD that generates ultraviolet light having a wavelength near 365 nm. The LD emits linearly-polarized light.

The collimator lens 213 forms a parallel beam by transmitting ultraviolet light L_{UV} emitted from the light source 212. The beam splitter 214 transmits and guides a part of incident light to the polarization beam splitter 221, and reflects and guides the rest of the incident light to the photodetector 215. An output signal from the photodetector 215 is fed back to the drive circuit 211 and used for light quantity adjustment of the ultraviolet light to be outputted from the light source 212.

On the other hand, the drive circuit 216 controls the operation of the light source 217. Further, the light source 217 is a light source that outputs light different in wavelength from the output light of the light source 212. The light emitted from the light source 217 may be ultraviolet light or visible light. In the embodiment, an LD that outputs visible light L_{VS} having a wavelength near 650 nm is used.

The collimator lens 218 forms a parallel beam by transmitting the light L_{VS} emitted from the light source 217. The beam splitter 219 transmits and guides a part of incident light to the polarization beam splitter 221, and reflects and guides the rest of the incident light to the photodetector 220. An output signal from the photodetector 215 is fed back to the drive circuit 216 and used for light quantity adjustment of the light to be outputted from the light source 217.

The polarization beam splitter 221 transmits the entering P-polarized component without change and reflects the S-polarized component to change the optical path thereof.

Here, in the embodiment, the P-polarized component of the ultraviolet light L_{UV} outputted from the light source 212 is used as detection light and the S-polarized component of the visible light L_{VS} outputted from the light source 217 is used as reference light. Accordingly, the position and the angle of the optical system within the light source unit 210 is adjusted such that the ultraviolet light L_{UV} enters the polarization beam splitter 221 in the P-polarized state and the visible light L_{VS} enters the polarization beam splitter 221 in the S-polarized state. Thereby, a light beam as mixture of the P-polarized component of the ultraviolet light and the S-polarized component of the visible light is formed and guided toward the optical chopper 222.

The optical chopper 222 controls the timing of light output from the light source unit 210 by chopping the light beam formed by the polarization beam splitter 221 with predetermined timing or at a predetermined frequency. Further, an ON/OFF signal outputted from the optical chopper 222 is inputted to the signal amplifier 140 and used for lock-in operation in the signal amplifier 140.

The light quantity comparison part 223 obtains a ratio of light quantities of the light respectively outputted from the light sources 212 and 217 and outputs a signal representing the ratio of light quantities to the signal processing unit 150. The signal representing the ratio of light quantities is used when the calculated wafer temperature is corrected.

Here, positions and angles of the light source unit 210, the prisms 121 and 122, wafer 100, and light receiving unit 230 are adjusted such that the ultraviolet light L_{UV} contained in the light beam outputted from the light source 210 enters wafer 100 in the P-polarized state and the visible light L_{VS} enters the wafer 100 in the S-polarized state. Further, the incident angle to the wafer 100 is desirably from substantially 35° to substantially 85° as that explained in the first embodiment.

The light receiving unit 230 includes a polarization beam splitter 231, wavelength selection filters 232 and 235, lenses 233 and 236 and photodetectors (PD) 234 and 237.

The polarization beam splitter 231 splits the ultraviolet light L_{R} entering the light receiving unit via the prism 122 from the wafer 100 into a P-polarized component and an S-polarized component by reflecting or transmitting the light according to the polarization direction. The P-polarized component L_{UVP} of the ultraviolet light split by the polarization beam splitter 231 is transmitted through the wavelength selection filter 232 and guided toward the wavelength selection filter 232 and the S-polarized component L_{VSS} of the visible light is reflected by the wavelength selection filter 232 and guided toward the wavelength selection filter 235.

The wavelength selection filter 232 is a filter that responds to the light source 212 and selectively transmits wavelength components having wavelengths near 365 nm. The wavelength selection filter 232 is provided for preventing the mixture of unwanted disturbance light into the downstream. The condenser lens 233 collects the P-polarized component L_{UVP} of the ultraviolet light transmitted through the wavelength selection filter 232 and guides it to the photodetector 234. The photodetector 234 detects the P-polarized component L_{UVP} to generate and output an electrical signal (detection signal Y₁) according to the light intensity.

On the other hand, the wavelength selection filter 235 is a filter that responds to the light source 217 and selectively transmits wavelength components having wavelengths near 650 nm. The condenser lens 236 collects the S-polarized component L_{VSS} of the visible light transmitted through the wavelength selection filter 234 and guides it to the photodetector 237. The photodetector 237 detects the S-polarized component L_{VSS} to generate and output an electrical signal (reference signal Y₂) according to the light intensity.

In the signal processing unit 150, the temperature of the wafer 100 is calculated based on the detection signal Y₁ and the reference signal Y₂ inputted via the signal amplifier 140. The calculation method is the same as that explained in the first embodiment. In this regard, the signal intensity of the detection signal Y₁ and the reference signal Y₂ is corrected based on the signal representing the ratio of light quantities outputted from the light quantity comparison part 223 of the light source unit 210.

In the above explained embodiment, the polarization beam splitters are used when the light L_{UV} and the light L_{VS} having different wavelengths from each other are mixed and when the reflection light from the wafer 100 is split into the P-polarized component L_{UVP} and the S-polarized component L_{VSS}, however, other optical elements, optical devices and so on may be used. For example, in place of the polarization beam splitter 221 shown in FIG. 8, a dichroic mirror that reflects or transmits light according to its wavelength may be used. In this case, the polarization direction of the visible light L_{VS} outputted from the light source 217 relative to the dichroic mirror may not be the S-polarized direction.

In the embodiment, the lights output from the different light sources 212 and 217 have been once mixed, and the detection light L_{UVP} and the reference light L_{VSS} pass the same optical path until split by the polarization beam splitter 231 of the light receiving unit 230. Accordingly, the influence by the variation in optical path or the like can be cancelled by taking the relative value between the detection light and the reference light, and thereby, temperature measurement can be performed with higher accuracy.

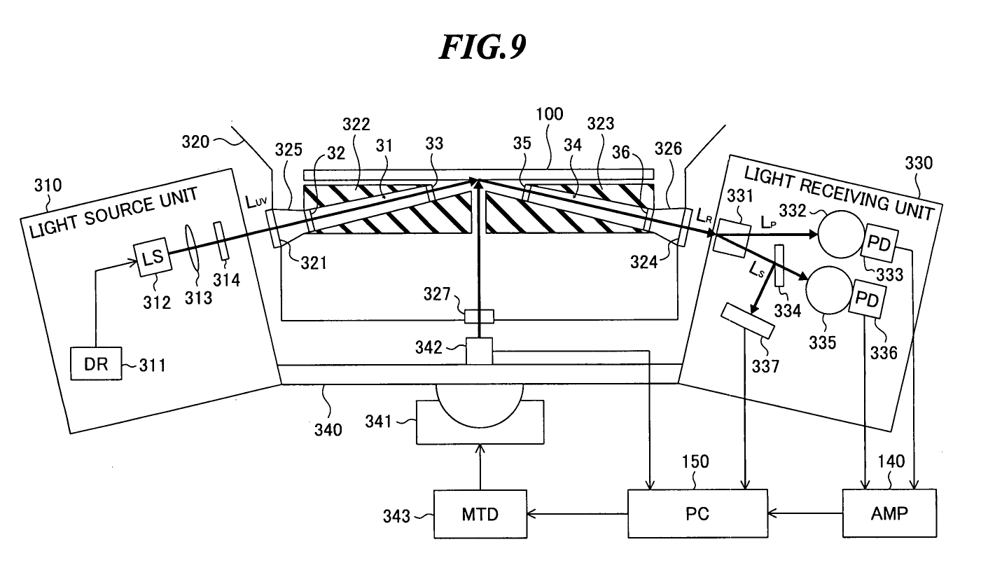

Next, a wafer temperature measuring apparatus according to the third embodiment of the present invention will be explained. FIG. 9 is a schematic diagram showing a configuration of the wafer temperature measuring apparatus according to the embodiment. The wafer temperature measuring apparatus is an apparatus for measuring the temperature of the wafer 100 by using a P-polarized component of ultraviolet light as detection light and using an S-polarized component having the same wavelength as that of the detection light as reference light.

As shown in FIG. 9, the wafer temperature measuring apparatus according to the embodiment includes a light source unit 310, a chamber 320, a light receiving unit 330, the signal amplifier 140, the signal processing unit 150, a supporting unit 340, a mechanical stage 341, an auto-collimator 342 and a mechanical stage driving unit 343. The configuration and operation of the signal amplifier 140 and the signal processing unit 150 are the same as those in the wafer temperature measuring apparatus shown in FIG. 4.

The light source unit 310 includes a drive circuit (DR) 311, a light source (LS) 312, a collimator lens 313 and a wavelength selection filter 314.

The drive circuit 311 controls the operation of the light source 312. Further, the light source 312 is, for example, a high-pressure mercury lamp or mercury xenon lamp that generates ultraviolet light containing a wavelength component having a wavelength near 365 nm as a mercury line. Alternatively, an LED that generates ultraviolet light having a wavelength near 375 nm may be used. These light sources generate non-polarized light.

Alternatively, as the light source 312, a light source that generates polarized light like an ultraviolet laser may be used. In the case, in order to make the P-polarized component and the S-polarized component nearly equal in the reflection light from the wafer 100, it is desired to adjust the polarization direction such that the ratio of the P-polarized component to the S-polarized component becomes about 3:1 in the incident light to the wafer 100.

The collimator lens 313 forms a parallel beam by transmitting ultraviolet light emitted from the light source 312. The wavelength selection filter 314 is a bandpass filter that cuts out the wave components near 365 nm from the parallel beam transmitted through the collimator lens 313 and transmits them.

Within the chamber 320, heaters 322 and 323 for maintaining the wafer 100 at a predetermined temperature in the semiconductor manufacturing process are provided. The light to be used for measuring the wafer temperature is introduced through a window 321 into the chamber 320, passes through optical path channels 31 and 34 respectively formed within the heaters 322 and 323, and guided through a window 324 out of the chamber 320.

The optical path channel 31 provided within the heater 322 is formed by forming a hole in the heater 322 and disposing windows 32 and 33 on both ends thereof. Similarly, the optical path channel 34 within the heater 323 is formed by forming a hole in the heater 323 and disposing windows 35 and 36 on both ends thereof. These windows 32, 33, 35 and 36, and the windows 321 and 326 of the chamber 320 are positioned so as to be perpendicular or nearly perpendicular to incident light L_{UV} and reflection light L_{R} passing through them. When only a little impurity adheres to the boundary surface of the window or the like or temperature change occurs, the transmittance of the light passing through them changes, however, as long as the light enters the boundary surface perpendicularly thereto, the ratio of the P-polarized component to the S-polarized component can be kept.

Furthermore, covers for preventing impurity adhesion 325 and 326 are provided between the windows 321 and 32, and the windows 36 and 324, respectively.

The light receiving unit 330 includes a Wollaston prism 331, integrating spheres 332 and 335, photodetectors (PD) 333 and 336, a beam splitter 334 and a position detection sensor 337.

The Wollaston prism 331 is a polarizing prism that branches the linearly-polarized lights perpendicular to each other, and splits the reflection light L_{R} from the wafer 100 into P-polarized component L_{P} and S-polarized component L_{S} and guides them to the integrating sphere 332 and the beam splitter 334, respectively.

The integrating spheres 332 and 335 are hollow spheres having ports for incident light, detectors, or the like and materials applied on the entire inner surfaces thereof. The photodetectors 333 and 336 are provided at the ports for detectors of the integrating spheres 332 and 335, and the lights entering the integrating spheres are guided to the detection surfaces of the photodetectors 333 and 336 regardless of orientation at the time of incidence.

The reason for using such integrating spheres 332 and 335 is as follows. For example, sometimes variations in optical paths from the wafer 100 to the photodetectors 333 and 336 are caused by the influence of thermal expansion due to temperature change or the like. In the case, when the position of incident light relative to the detection surface of the photoconductor is displaced, the detection intensity may change due to nonuniformity of photosensitivity on the detection surface or the like. If such changes are equal between the detection light (P-polarized component) and the reference light (S-polarized component), the error can be canceled by taking the ratio between them. However, when the changes are caused after the light is separated into the detection light and the reference light by the Wollaston prism 331, the difference between the changes appear in measurement accuracy. Accordingly, in the embodiment, the influence by the variations in optical paths is minimized by providing the integrating spheres 332 and 335 at the upstream of the photodetectors 333 and 336.

The P-polarized component L_{P} of ultraviolet light separated by the Wollaston prism 331 enters the photodetector 333. The photodetector 333 detects the entering light and outputs an electrical signal according to light intensity as detection signal Y₁.

Further, the S-polarized component L_{S} of ultraviolet light separated by the Wollaston prism 331 is split into two parts respectively in two directions by the beam splitter 334. The one part of S-polarized component L_{S} split by the beam splitter 334 enters the photodetector 336 via the integrating sphere 335. The photodetector 336 detects the intensity of the entering light and outputs an electrical signal according to the light intensity as reference signal Y₂. Further, the other part of S-polarized component split by the beam splitter 334 enters the position detection sensor 337. The position detection sensor 337 detects the displacement of the incident light based on the incident light and outputs a detection signal. The signal processing unit 150 calculates the temperature of the wafer 100 based on the detection signal Y₁ and the reference signal Y₂ inputted via the signal amplifier 140, calculates the displacement of the relative position of the wafer 100 and the light receiving unit 330 based on the detection signal outputted from the position detection sensor 337, and further, obtains an amount of correction of the position of the light receiving unit 330.

The supporting unit 340 is formed by a material having a small coefficient of thermal expansion such as inver (low-expansion alloy) or polycrystalline glass, and supports the light source unit 310 and the light receiving unit 330 so as to maintain the positional relationship to each other. Further, the supporting unit 340 is provided with the mechanical stage 341, the auto-collimator unit 342, and the mechanical stage driving unit (MTD) 343.

The mechanical stage 341 performs vertical position adjustment (in the distance direction from the wafer 100) and angle adjustment of two axes in tilting directions on the supporting unit 340. Thereby, the positions and angles of the ultraviolet light L_{UV} outputted from the light source 310 and entering the wafer 100 and the reflection light L_{R} reflected from the wafer 100 and received by the light receiving unit 330 are adjusted.

The auto-collimator unit 342 applies light to the wafer 100 via the window 327 provided in the chamber 320, detects the position and angle of the light reflected by the wafer 100, and outputs a detection signal to the signal processing unit 150. The signal processing unit 150 calculates the variations in the position and angle of the supporting unit 340 relative to the wafer 100 based on the detection signal, and further, obtains an amount of correction of the supporting unit 340.

The mechanical stage driving unit 343 controls the mechanical stage 341 based on the amount of correction calculated based on the detection signal of the auto-collimator unit 342 and the amount of correction calculated based on the detection signal of the position detection sensor 337, and thereby, performs alignment between the light source unit 310 and the light receiving unit 330 and the wafer 100.

In the above explained embodiment, non-polarized light is allowed to enter the wafer 100 using the high-pressure mercury lamp or the like as the light source 312. However, the polarized light may be allowed to enter the wafer 100 by inserting a polarizer into the light source unit 310 or at the upstream of the chamber 320. In the case, as described above, in order to make the P-polarized component and the S-polarized component nearly equal in the reflection light from the wafer 100, the angle of the inserted polarizer is adjusted such that the ratio of the P-polarized component to the S-polarized component becomes about 3:1 in the incident light to the wafer 100.

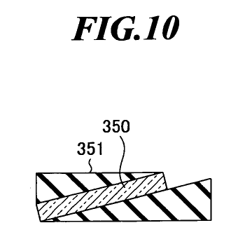

FIG. 10 is a diagram for explanation of a modified example of the wafer temperature measuring apparatus according to the third embodiment of the present invention. In the wafer temperature measuring apparatus shown in FIG. 9, in place of the optical path channels containing the incident window 32 to output window 33 and the incident window 35 to output window 36, a rod 350 with a heater 351 formed around it as shown in FIG. 10 may be provided. The rod 350 is fabricated of a material that transmits ultraviolet light such as quartz. Using such a rod 350, impurity adhesion to the middle of the optical path (e.g., both end surfaces of the window 32) and environmental changes (e.g., thermal disturbance of gases) can be prevented, and thereby, the ratio of the P-polarized component to the S-polarized component contained in the ultraviolet light passing through the rod can be prevented from varying.

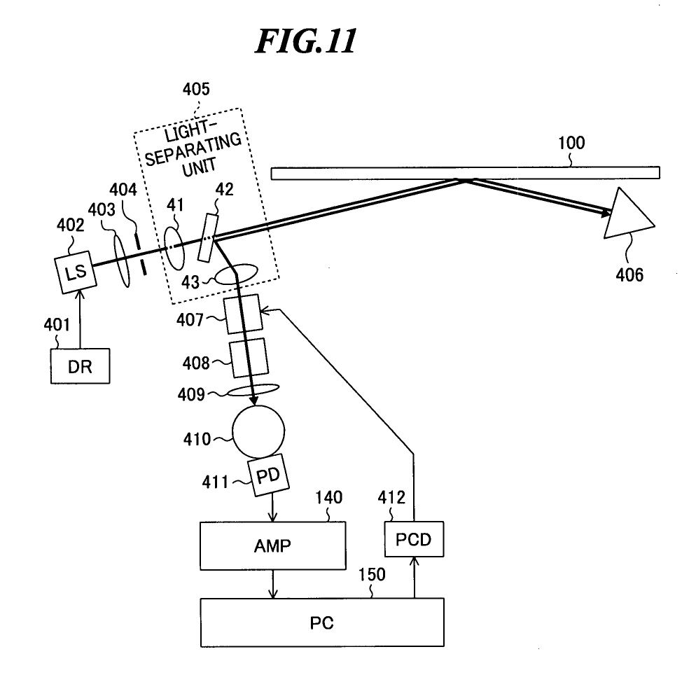

Next, a wafer temperature measuring apparatus according to the fourth embodiment of the present invention will be explained. FIG. 11 is a schematic diagram showing a configuration of the wafer temperature measuring apparatus according to the embodiment. The wafer temperature measuring apparatus is characterized in that ultraviolet light containing a P-polarized component is used as detection light and ultraviolet light containing an S-polarized component is used as reference light, and the same optical path is taken in incident light to the wafer 100 and reflection light from the wafer 100.

As shown in FIG. 11, the wafer temperature measuring apparatus according to the embodiment includes a drive circuit (DR) 401, a light source (LS) 402, a collimator lens 403, an aperture 404, a light-separating unit 405, a reflector element 406, a light modulator 407, a polarizer 408, a condenser lens 409, an integrating sphere 410, a photodetector (PD) 411, a light modulator driving unit (PCD) 412, the signal amplifier 140 and the signal processing unit 150. The configuration and operation of the signal amplifier 140 and the signal processing unit 150 are the same as those in the wafer temperature measuring apparatus shown in FIG. 4.

The drive circuit 401 controls the operation of the light source 402. Further, the light source 402 is, for example, a high-pressure mercury lamp or mercury xenon lamp that generates ultraviolet light containing a wavelength component having a wavelength near 365 nm as a mercury line. Alternatively, an LED that generates ultraviolet light having a wavelength near 375 nm may be used. These light sources generate non-polarized light, and the polarized light may be outputted by providing a polarizer at the downstream of the light source 402, or a light source that generates polarized light may be used. In those cases, it is necessary to adjust the polarization direction such that the ratio of the P-polarized component to the S-polarized component becomes a predetermined ratio in the incident light to the wafer 100 as is the case explained in the third embodiment.

The collimator lens 403 forms a parallel beam by transmitting ultraviolet light outputted from the light source 402. Further, the aperture 404 forms a beam having a predetermined diameter by allowing the parallel beam to pass therethrough.

The light-separating unit 405 has plural beam splitters 41 to 43 formed by the same material and placed closely under the thermally same environment. Each of the beam splitters 41 to 43 allows light incident from the first direction to pass through in the second direction, and allows reflection light returned from the second direction to pass through in the third direction different from the first direction. Further, the beam splitters 41 and the beam splitter 42 are positioned such that they form 90° relative to each other with an optical axis as a rotational axis, and the beam splitter 42 and the beam splitter 43 are positioned such that they form 90° relative to each other with an optical axis as a rotational axis. When the light outputted from the light source 402 and passing through the collimator lens 403 and the aperture 404 is introduced into the light-separating unit 405, the light is transmitted through the beam splitters 41 and 42 and guided toward the wafer 100. The return light from the wafer 100 is reflected by the beam splitters 42 and 43 and guided toward the light modulator 407.

The advantage to provide the plural beam splitters 41 to 43 is as follows. Generally, an optical element such as a beam splitter has polarization dependence, and thus, when it reflects or transmits light, the polarization state (ratio of the P-polarized component and the S-polarized component) changes in the light after reflection or transmission. Accordingly, in the embodiment, the change in polarization state is prevented based on the following principle.

Given that the transmittance of the P-polarized component is T_{P} and the transmittance of the S-polarized component is T_{S} in the beam splitter 41, in the beam splitter 42 rotated at 90° relative to the beam splitter 41, the transmittance of the P-polarized component T_{P}′ and the transmittance of the S-polarized component T_{S}′ are represented as T_{P}′=T_{S} and T_{S}′=T_{P}.

Further, given that the intensity of the P-polarized component of the light incident to the beam splitter 41 is I_{P} and the intensity of the S-polarized component is I_{S}, the intensity of those polarized components changes to I_{P}×T_{P} (P-polarized component) and I_{S}×T_{S} (S-polarized component) after the light is transmitted through the beam splitter 41. When the light is further transmitted through the beam splitter 42, the light intensity after transmission changes as follows.

P-polarized component: I_{P}×T_{P}×T_{P}′=I_{P}×T_{P}×T_{S}

S-polarized component: I_{S}×T_{S}×T_{S}′=I_{S}×T_{S}×T_{P}

Consequently, the ratio of the P-polarized component to the S-polarized component does not change before incidence to the beam splitter 41 and after transmission through the beam splitter 42.

Further, given that the reflectance of the P-polarized component is R_{P} of the beam splitter 42 and the reflectance of the S-polarized component is R_{S}, in the beam splitter 43 rotated at 90° relative to the beam splitter 42, the reflectance of the P-polarized component R_{P}′ and the reflectance of the S-polarized component R_{S}′ are represented as R_{P}=R_{S} and R_{S}′=R_{P}. Accordingly, the return light from the wafer 100 is reflected by the beam splitters 42 and 43 and changes as follows. Here, the intensity of the P-polarized component is I_{P}′ and the intensity of the S-polarized component is I_{S}′ in the return light from the wafer 100.

P-polarized component: I_{P}′×R_{P}×R_{P}′=I_{P}′×R_{P}×R_{S}

S-polarized component: I_{S}′×R_{S}×R_{S}′=I_{S}′×R_{S}×R_{P}

Similarly, the ratio of the P-polarized component to the S-polarized component does not change before incidence to the beam splitter 41 and after transmission through the beam splitter 42.

Furthermore, the beam splitters 41 to 43 are placed closely under the thermally same environment and the polarization dependences thereof are made equal, and thereby, the change in polarization state is effectively suppressed.

The reflector element 406 further reflects the light entering the wafer 100 from the direction of the light-separating unit 405 and reflected by the wafer 100 to allow the light to enter the wafer 100 again. As the reflector element 406, a total reflection mirror, right angle prism, corner cube prism, or the like is used. Among them, the corner cube prism is desirable because it can fold incident light to 180° toward the incident direction regardless of the incident direction utilizing internal total reflection of three surfaces perpendicular to one another, and thereby, accommodates the change in incident angle caused by the deformation of the wafer 100 or the like.

The light modulator 407 is formed by a Pockels cell, for example, and changes the polarization direction of light transmitted through it according to an electrical signal to be supplied. Here, the Pockels cell is an optical element utilizing the EO (electro-optic) effect that the refractive index and anisotropy of a crystal change when an electric field is applied to the crystal. By controlling the electric field applied to the Pockels cell, the polarization direction of light transmitted through it can be rotated to a predetermined angle (e.g., 90°). Such operation of the light modulator 407 is controlled by an electrical signal supplied from the light modulator driving unit 412.

The polarizer 408 transmits a predetermined polarized component contained in the light transmitted through the light modulator 407. In the embodiment, the polarizer 408 transmits the P-polarized component incident to the polarizer 408.

The condenser lens 409 collects and allows the light transmitted through the polarizer 408 to enter the integrating sphere 410. Further, the integrating sphere 410 guides the incident light to the detection surface of the photodetector 411. These condenser lens 409 and integrating sphere 410 are provided for suppressing the change in intensity of the detection signal caused by optical path change due to temperature. Furthermore, the photodetector 411 detects the incident light and outputs an electrical signal according to the light intensity.

The light modulator driving unit 412 generates electrical signals for activating the light modulator 407 at predetermined intervals and supplies them to the light modulator 407 under the control of the signal processing unit 150.

When the light modulator 407 is not activated, the light reflected from the wafer 100 and entering the light modulator 407 via the light-separating unit 405 is not changed in polarization direction and transmitted through the light modulator 407. Thereby, the P-polarized component contained in the reflection light from the wafer 100 is transmitted through the polarizer 408. On the other hand, when the light modulator 407 is activated, the polarization direction of the reflection light from the wafer 100 is rotated to 90° by the light modulator 407. Thereby, the P-polarized component in the rotated polarization direction (i.e., S-polarized component contained in the reflection light from the wafer 100) is transmitted through the polarizer 408. Thus, by switching the activation state of the light modulator 407, the P-polarized component and the S-polarized component contained in the reflection light from the wafer 100 are alternately detected by the photodetector 411 via the condenser lens 409 and integrating sphere 410. Thereby, a signal (detection signal Y₁) representing the P-polarized component and a signal (reference signal Y₂) representing the S-polarized component are inputted to the signal processing unit 150 in a time-sharing mode.

The signal processing unit 150 loads the detection signal from the signal amplifier 140 in synchronization with the signal generation timing by the light modulator driving unit 412. Then, the temperature of the wafer 100 is calculated based on the signal (detection signal Y₁) detected when the light modulator 407 is not activated and the signal (reference signal Y₂) detected when the light modulator 407 is activated. The calculation method of the temperature is the same as that explained in the first embodiment.

As described above, according to the embodiment, the wafer temperature is measured based on the reflection light that has been reflected twice by the wafer 100, and thereby, sensitivity twice higher than that in the case of using the reflection light that has been reflected once can be obtained. Further, the detection light and the reference light take the same optical path after outputted from the light source 402 before detected by the photodetector 411, and thereby, the error caused by the variation in optical path or the like can be canceled with high accuracy. By the way, the wafer temperature may be measured based on the reflection light that has been three or more times by the wafer 100 by further providing an optical system of a reflection prism and the like.

Next, a wafer temperature measuring apparatus according to the fifth embodiment of the present invention will be explained.

The wafer temperature measuring apparatuses according to the fifth and eighth embodiments explained as below are for measuring a wafer temperature with accuracy in situ even in a low temperature process regardless of the surface condition of a target of temperature measurement (e.g., even in the case where an oxide film is formed on a silicon wafer).

When considering the measurement of a sample temperature by applying light containing a P-polarized component of ultraviolet light to the sample and detecting the P-polarized component of ultraviolet light reflected from the sample as described by referring to FIGS. 1-3, the inventors of the present invention have found that the reflection intensity of the P-polarized component of ultraviolet light is significantly affected by the surface condition of the target of temperature measurement. Specifically, when the oxide film is formed on the silicon surface, multiple reflections occur between the oxide film surface and the silicon surface, and thereby, the reflection intensity greatly varies due to the thickness of the oxide film. Further, the status of variation is not uniform because the properties of the oxide film differ depending on the kind of the target of temperature measurement.

Therefore, in order to correctly calculate the temperature of the measurement target, the inventors of the present invention focused attention on A_{UVP}/A_{S1} as a ratio of reflection intensity A_{UVP} of the P-polarized component of ultraviolet light that is sensitive to the temperature change of the measurement target to the S-polarized component A_{S1} that is not so much affected by the temperature change, and A_{VSP}/A_{S2} as a ratio of reflection intensity A_{VSP} of the P-polarized component of visible light that are not so much affected by the temperature change to the S-polarized component A_{S2}. The ratio A_{UVP}/A_{S1} is a function of the temperature of the measurement target and the surface condition (oxide film thickness), while the ratio A_{VSP}/A_{S2} is a function almost only of the surface condition. Therefore, the influence on the temperature measurement by the wafer surface condition can be removed by using these ratios.

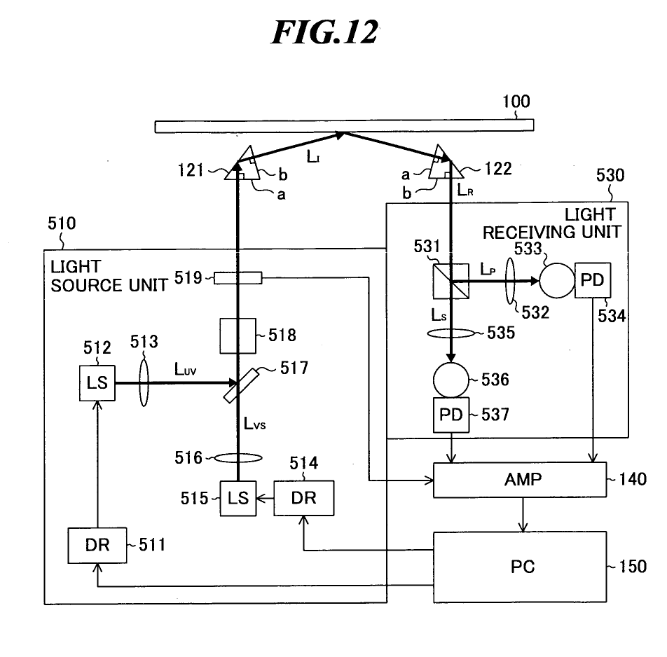

FIG. 12 is a schematic diagram showing a configuration of the wafer temperature measuring apparatus according to the fifth embodiment of the present invention. The wafer temperature measuring apparatus according to the embodiment includes a light source unit 510, the prisms 121 and 122, a light receiving unit 530, the signal amplifier (AMP) 140 and the signal processing unit 150. The prisms 121 and 122, the signal amplifier 140 and the signal processing unit 150 are the same as those in the wafer temperature measuring apparatus shown in FIG. 4.

The light source unit 510 includes drive circuits (DR) 511 and 514, light sources (LS) 512 and 515, collimator lenses 513 and 516, a wavelength combining element 517, a polarizer 518 and an optical chopper 519, and outputs light to be applied to the wafer 100.

The drive circuits 511 and 514 control the operation of the light sources 512 and 515, respectively.

The light source 512 is a light emitting diode (LED) that generates ultraviolet light (light having a wavelength of 400 nm or less) L_{UV} having a wavelength near 365 nm, for example. Further, the light source 515 is a light emitting diode that generates visible light (light having a wavelength larger than 400 nm) L_{VS} having a wavelength near 650 nm, for example.

The collimator lens 513 forms a parallel beam by transmitting the ultraviolet light L_{UV} outputted from the light source 512. Further, the collimator lens 516 forms a parallel beam by transmitting the visible light L_{VS} outputted from the light source 515.

The wavelength combining element 517 is formed by a dichroic mirror that reflects only a predetermined wavelength component, for example, and reflects the ultraviolet light L_{UV} propagated from the direction of the light source 512 and guides it toward the polarizer 518, and transmits the visible light L_{VS} propagated from the direction of the light source 515 and guides it toward the polarizer 518.

The polarizer 518 transmits and linearly-polarizes the light entering via the wavelength combining element 517.

Here, in order to make the intensity of the P-polarized component and the intensity of the S-polarized component nearly equal in the reflection light from the wafer 100, it is desirable that the polarization direction is adjusted in advance such that the amount of the P-polarized component is larger in the incident light to the wafer 100. Accordingly, in the embodiment, the angle of the polarizer 518 is adjusted such that the ratio of the P-polarized component to the S-polarized component becomes about 3:1 in the incident light to the wafer 100.

Note that the polarizer 518 is not required when light sources that output light that has been polarized in advance such as laser diodes (LD) are used as the light sources 512 and 515. In this case, it is necessary to adjust the positions of the light sources 512 and 515 such that the light enters the wafer 100 in a suitable polarization state.

The optical chopper 519 controls the timing of light output from the light source unit 510 by chopping the ultraviolet light linearly-polarized by the polarizer 518 with predetermined timing or at a predetermined frequency. Further, the optical chopper 519 outputs an ON/OFF signal to the signal amplifier 140.

The light receiving unit 530 includes a polarization beam splitter (polarizing prism) 531, lenses 532 and 535, integrating spheres 533 and 536 and photodetectors (PD) 534 and 537, and receives the light L_{R} reflected by the wafer 100.

The polarization beam splitter 531 splits the entering light L_{R} according to the polarization direction, guides the P-polarized component L_{P} of the light toward the condenser lens 532, and guides the S-polarized component Ls toward the condenser lens 535.

The condenser lens 532 collects and guides the entering P-polarized component L_{P} to the integrating sphere 533. Further, the condenser lens 535 collects and guides the entering S-polarized component L_{S} to the integrating sphere 536. By providing the lenses 532 and 535, even when the position and direction of the optical path vary to some degree, the influence by the variation can be minimized and the P-polarized component L_{P} and the S-polarized component L_{S} can reliably enter the downstream optical system.

The photodetectors 534 and 537 are provided at the ports for detectors of the integrating spheres 533 and 536, and the lights entering the integrating spheres are guided to the detection surfaces of the photodetectors 534 and 537 regardless of orientation at the time of incidence. The influence by the variation in optical path between the P-polarized component L_{P} and the S-polarized component L_{S} after branched by the polarization beam splitter 531 can be minimized by the integrating spheres 533 and 536.

The photodetectors 534 and 537 include photoelectric conversion elements such as photodiodes (PD), for example. The photodetector 534 generates and outputs an electrical signal (detection signal) representing the intensity of the P-polarized component L_{P}. Further, photodetector 537 generates and outputs an electrical signal (detection signal) representing the intensity of the S-polarized component L_{S}.

The positional and angular relationships of these light source unit 510, prisms 121 and 122, wafer 100 and light receiving unit 530 are adjusted such that the incident angle becomes substantially 35° to substantially 85°, more desirably substantially 60° to substantially 75° when the light L_{I} outputted from the light source unit 510 enters the wafer 100 for the same reason as that explained in the first embodiment.

The signal processing unit 150 controls the respective units of the wafer temperature measuring apparatus and calculates the wafer temperature. The signal processing unit 150 controls the drive circuits 511 and 514 of the light source 510 to alternately operate in a time-sharing mode, and thus, the detection signal D_{UVP} representing the intensity of the P-polarized component of the ultraviolet light and the detection signal D_{VSP} representing the intensity of the P-polarized component of the visible light are alternately outputted from one photodetector 534. Further, the detection signal D_{UVS} representing the intensity of the S-polarized component of the ultraviolet light and the detection signal D_{VSS} representing the intensity of the S-polarized component of the visible light are alternately outputted from the other photodetector 537. The signal processing unit 150 calculates the temperature of the wafer 100 based on the detection signals D_{UVP}, D_{UVS}, D_{VSP} and D_{VSS} acquired as above.

The temperature T of the wafer 100 is calculated by using the function f (D_{UVP}, D_{UVS}, D_{VSP}, D_{VSS}) with four detection signals D_{UVP}, D_{UVS}, D_{VSP} and D_{VSS} as variables and previously calibrated parameters. The function f (D_{UVP}, D_{UVS}, D_{VSP}, D_{VSS}) and the parameters are obtained, for example, by detecting detection light and reference light while measuring the temperature of a test wafer by a contact method and performing computation (e.g., regression analysis or the like) using actual measurement values and the detection signals D_{UVP}, D_{UVS}, D_{VSP} and D_{VSS} in the temperature measuring apparatus shown in FIG. 12.

Specifically, there is a calculation method as below, for example.

First, using the following equations (1) and (2), the relative value R_{UV} of the intensity of the P-polarized component to the S-polarized component of ultraviolet light and the relative value R_{VS} of the intensity of the P-polarized component to the S-polarized component of visible light are obtained from the reflection light from the wafer 100.
R_{UV}=(a₁D_{UVP}²+a₂D_{UVP}+a₃)/(a₄D_{UVS}²+a₅D_{UVS}+a₆) (1)
R_{VS}=(b₁D_{VSP}²+b₂D_{VSP}+b₃)/(b₄D_{VSS}²+b₅D_{VSS}+b₆) (2)
In the equations (1) and (2), a₁ to a₆ and b₁ to b₆ are previously calibrated parameters.

Then, using the relative value R_{VS} obtained by the equation (2), the correction parameters x₁ to x₃ are calculated by the following equations (3) to (5).
x₁=c₁R_{VS}²+C₂R_{VS}+C₃ (3)
x₂=d₁R_{VS}²+d₂R_{VS}+d₃ (4)
x₃=e₁R_{VS}²+e₂R_{VS}+e₃ (5)
In the equations (3) to (5), c₁ to c₃, d₁ to d₃, and e₁ to e₃ are previously calibrated parameters.

Further, using R_{UV} obtained by the equation (1) and the correction parameters x₁ to x₃, the temperature T is calculated by the following equation (6).
T=x₁R_{UV}²+x₂R_{UV}+x₃ (6)

Here, the relative value R_{UV} expressed by the equation (1) is a function of a wafer temperature and surface condition because it represents a relationship between the P-polarized component of ultraviolet light that is sensitive to the temperature change of the wafer and affected by the surface condition (oxide film thickness) of the wafer and the S-polarized component of ultraviolet light that is not so much affected by the temperature change of the wafer but affected by the surface condition of the wafer. On the other hand, the relative value R_{VS} expressed by the equation (2) is a function almost of wafer surface condition because it represents a relationship between the P-polarized component of visible light and the S-polarized component of visible light both are not so much affected by the temperature change of the wafer but affected by the surface condition of the wafer. Therefore, using the relative value R_{UV} and the correction parameters x₁ to x₃ obtained based on the relative value R_{VS}, the influence of the oxide film formed on the wafer surface or the like can be removed and the correct wafer temperature can be calculated.

In the embodiment, although the relative values R_{UV} and R_{VS} of the P-polarized component to the S-polarized component in the reflection light L_{UV} and L_{VS} from the wafer 100 are calculated based on the equations (1) and (2), the relative values may merely be ratios of the P-polarized component to the S-polarized component, or calculated based on a function other than the quadratic function expressed by the equations (1) and (2).

Further, the relative values may be used, not limited to the combination as described in the embodiment, as reference value and correction value. That is, the S-polarized component as a basic value (denominator of the relative value) does not necessarily have the same wavelength as that of the P-polarized component. Specifically, the same S-polarized component may be used as a basic value between the two relative values (e.g., D_{UVP}/D_{VSS} and D_{VSP}/D_{VSS}, or D_{UVP}/D_{UVS} and D_{VSP}/D_{UVS}) or the P-polarized components and the S-polarized components may be cross-coupled between the two relative values (e.g., D_{UVP}/D_{VSS} and D_{VSP}/D_{UVS}). This is because the components other than the P-polarized component of ultraviolet light are not so much affected by the wafer temperature change and they only represents the wafer surface condition.

In the embodiment, although the correction parameters are separately obtained and the temperature T is calculated as the function f (R_{UV}) of the relative value R_{UV}, the temperature T may be calculated by the function f′ (R_{UV}, R_{VS}) of the relative values R_{UV} and R_{VS}, and further, may be calculated by the function f″ (D_{UVP}, D_{UVS}, D_{VSP}, D_{VSS}) of the detection signals D_{UVP}, D_{UVS}, D_{VSP} and D_{VSS}.

Further, the equations for obtaining the function of the temperature T and the correction parameters are not necessarily the quadratic functions expressed by the equations (3) to (6), but linear functions or other multidimensional functions may be used. Sometimes the functions may be complex depending on the magnitude of wavelengths of ultraviolet light and visible light applied to the wafer 100 or the combination of the wavelengths. Further, in a strict sense, the S-polarized component and the P-polarized component of ultraviolet light contained in the reflection light from the wafer are also affected by the temperature and the condition of the boundary surface between the wafer and the oxide film in addition to the oxide film. Therefore, it is conceivable that more complex functions are necessary in the case where the intensity of the S-polarized component and so on are calibrated based on the actual measurement values. However, there is no problem in use of the method as described in the embodiment because such an influence is much smaller in wavelength compared to the temperature dependence of the P-polarized component of ultraviolet light.

As above, the case where the temperature of the wafer 100 obtained based on the P-polarized component of ultraviolet light is corrected according to the surface condition (adherent of oxide film or the like) of the wafer 100 has been explained. However, when there is no need for new correction such that there is no change in the thickness of the oxide film, only the drive circuit 514 may be operated under the control of the signal processing unit 150. Further, the correction may be performed according to need by operating the drive circuit 511 with predetermined timing or at predetermined intervals.

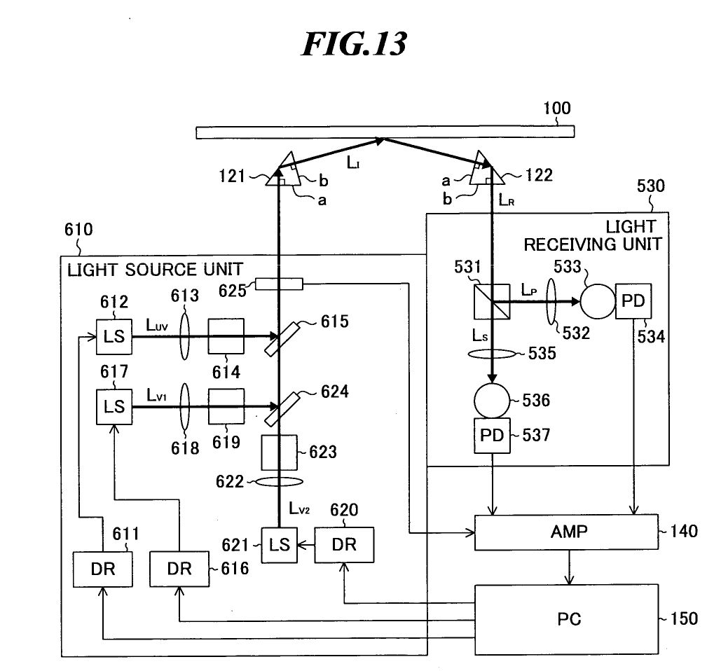

Next, a wafer temperature measuring apparatus according to the sixth embodiment of the present invention will be explained. FIG. 13 is a schematic diagram showing a configuration of the wafer temperature measuring apparatus according to the embodiment. In the embodiment, the apparatus is characterized in that the measurement accuracy is further improved by applying three kinds of light containing ultraviolet light to the wafer 100.

As shown in FIG. 13, the wafer temperature measuring apparatus according to the embodiment includes a light source unit 610, the prisms 121 and 122, the light receiving unit 530, the signal amplifier 140 and the signal processing unit 150. The configuration and operation of the prisms 121 and 122, the light receiving unit 530, the signal amplifier 140 and the signal processing unit 150 are the same as those in the wafer temperature measuring apparatus shown in FIG. 12.

The light source unit 610 includes drive circuits (DR) 611, 616 and 620, light sources (LS) 612, 617 and 621, collimator lenses 613, 618 and 622, polarizers 614, 619 and 623, wavelength combining elements 615 and 624, and an optical chopper 625.

The drive circuits 611, 616 and 620 control the operation of the light sources 612, 617 and 621, respectively. Further, the operation of the drive circuits 611, 616 and 620 are controlled to sequentially operate in a time-sharing mode by the signal processing unit 150.

The light source 612 generates ultraviolet light L_{UV} having a wavelength near 365 nm, for example. Further, the light source 617 generates visible light L_{V1} having a first wavelength. Furthermore, the light source 621 generates visible light L_{V2} having a second wavelength different from the first wavelength. In the embodiment, light emitting diodes that generate non-polarized light are used as the light sources 612, 617 and 621.

Note that light sources that output light that has been polarized in advance such as laser diodes (LD) may be used as the light sources 612, 617 and 621, and the downstream polarizers 614, 619 and 623 may be omitted. Further, in this case, it is necessary to adjust the positions of the light sources 612, 617 and 621 such that the light emitted from each light source enters the downstream wavelength combining element in a suitable polarization state.

The collimator lenses 613, 618 and 622 form parallel beams by transmitting the lights outputted from the light sources 612, 617 and 621, respectively.

The polarizers 614, 619 and 623 transmit and linearly-polarize the parallel beams entering via the collimator lenses.

The wavelength combining element (dichroic mirror) 615 reflects and guides the ultraviolet light L_{UV} entering via the polarizer 614 toward the optical chopper 625, and transmits other lights. The polarization direction of the polarizer 614 has been adjusted such that either of the P-polarized component or the S-polarized component of the light linearly-polarized by the polarizer 614 enters the wavelength combining element 615. Although the polarization state of the light (the ratio of the P-polarized component to the S-polarized component) reflected or transmitted by the dichroic mirror is affected by the change in environment such as a temperature in the dichroic mirror, the polarization state does not change when only one of the component enters.

The wavelength combining element 624 reflects and guides the visible light L_{V1} toward the optical chopper 625, and transmits and guides the other wavelength component, i.e., the visible light L_{V2} toward the optical chopper 625. In order to prevent the change in the polarization direction in the wavelength combining element 624, the polarization directions of the polarizers 619 and 623 have been adjusted such that either of the P-polarized component or the S-polarized component of the linearly-polarized light enters the wavelength combining element 624.

Furthermore, the wavelength combining elements 615 and 624 are positioned such that the ratio of the S-polarized component to the P-polarized component desirably becomes about 3:1 in the light entering the wafer 100 via the prism 121 as those explained in the fifth embodiment.

The optical chopper 625 controls the timing of light output from the light source unit 610 by chopping the ultraviolet light L_{UV} and the visible lights L_{V1} and L_{V2} guided by the wavelength combining elements 615 and 624 with predetermined timing or at a predetermined frequency. Further, the optical chopper 625 outputs an ON/OFF signal used for lock-in operation in the signal amplifier 140.

In the embodiment, three systems of light sources that sequentially operate in a time-shearing mode are provided in the light source unit 610. Accordingly, detection signal D_{UVP} representing the intensity of the P-polarized component of the ultraviolet light L_{UV}, detection signal D_{V1P} representing the intensity of the P-polarized component of the first visible light L_{V1}, and detection signal D_{V2P} representing the intensity of the P-polarized component of the second visible light L_{V2}, which have been reflected by the wafer 100, are sequentially outputted from the photodetector 534 of the light receiving unit. Further, detection signal D_{UVS} representing the intensity of the P-polarized component of the ultraviolet light L_{UV}, detection signal D_{V1S} representing the intensity of the P-polarized component of the first visible light L_{V1}, and detection signal D_{V2S} representing the intensity of the P-polarized component of the second visible light L_{V2}, which have been reflected by the wafer 100, are sequentially outputted from the photodetector 537. The signal processing unit 150 calculates the temperature of the wafer 100 based on those six kinds of detection signals.

Specifically, there is a calculation method as below, for example.

First, as is the case explained in the fifth embodiment of the present invention, the relative values R_{UV}, R_{V1}, R_{V2} of the P-polarized components to the S-polarized components in the reflection light L_{UV}, L_{V1}, L_{V2} from the wafer 100 by using the equation (1) and so on are obtained, respectively. The relative values may merely be ratios of the detection signals, D_{UVP}/D_{UVS}, D_{V1P}/D_{V1S} and D_{V2P}/D_{V2S}, or ratios of predetermined functions as is the fifth embodiment.

Then, using the equations (3) to (5), correction parameters x₁ to x₃ based on the relative value R_{V1} and correction parameters y₁ to y₃ based on the relative value R_{V2} are calculated. Further, average values z₁ to z₃ of the correction parameters are obtained based on the following equations.
z₁=(x₁+y₁)/2
z₂=(x₂+y₂)/2
z₃=(x₃+y₃)/2
Using the averaged correction parameters z₁ to z₃, the temperature T of the wafer 100 is calculated by the following equation (7).
T=z₁R_{UV}²+z₂R_{UV}+z₃ (7)

Thus, in the sixth embodiment of the present invention, more accurate correction can be performed in the temperature measurement of the wafer 100 by increasing the detection signals used for correction. Further, the accuracy of the correction can be more improved by further providing systems of light sources that generate visible light in the light source unit 610 shown in FIG. 13.

In the embodiment, as is the case of the fifth embodiment, the combination of the P-polarized component and the S-polarized component is not limited to one of the components having the same wavelength when the relative value R_{UV} and so on are obtained. That is, the relative value to the P-polarized component of ultraviolet light may be used as a variable of the function (equation (7)) for obtaining the temperature T and the other relative values may be used for the calculation of correction parameters. Further, various functions other than the quadratic functions may be used as equations for calculating the function of the temperature T and correction parameters. Furthermore, functions for directly calculating the temperature T with the relative values R_{UV}, R_{V1} and R_{V2} and D_{UVP}, D_{UVS}, D_{V1P}, D_{V1S}, D_{V2P} and D_{V2S} as variables may be used.

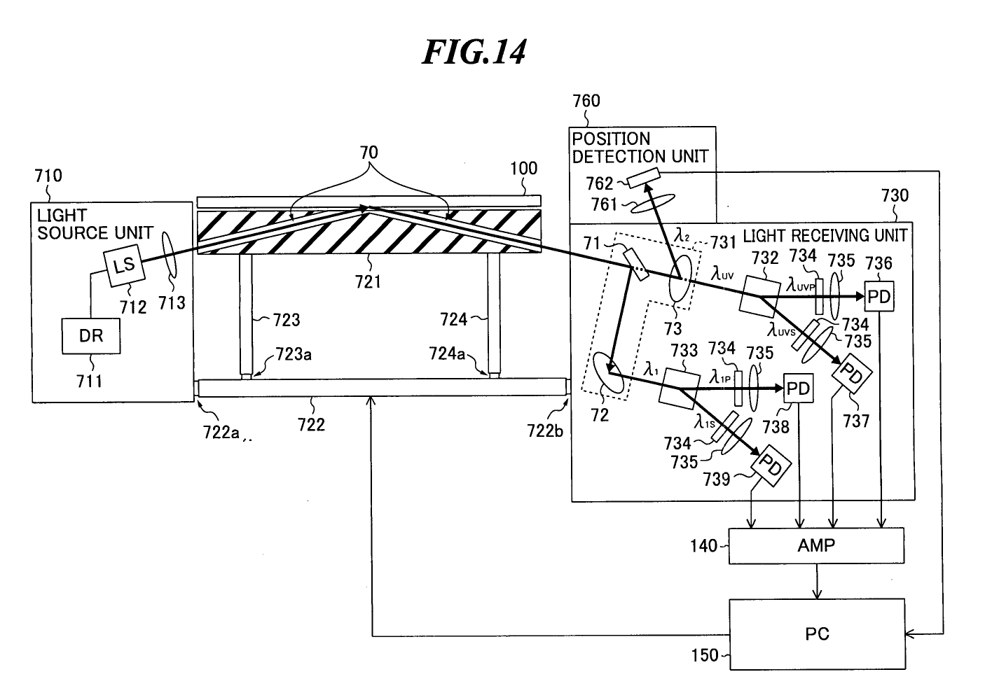

Next, a wafer temperature measuring apparatus according to the seventh embodiment of the present invention will be explained. FIG. 14 is a schematic diagram showing a configuration of the wafer temperature measuring apparatus according to the embodiment. In the embodiment, the apparatus is characterized in that the temperature is measured using one light source based on the reflection light from the wafer 100 and a mechanism for adjusting the optical axes of incident light to and reflection light from the wafer 100.

As shown in FIG. 14, the wafer temperature measuring apparatus according to the embodiment includes a light source unit 710, a wafer support table 721, a position adjustment mechanism 722 to 724, a light receiving unit 730, the signal amplifier 140, the signal processing unit 150 and a position detection unit 760. The configuration and operation of the signal amplifier 140 and the signal processing unit 150 are the same as those in the wafer temperature measuring apparatus shown in FIG. 12.

The light source unit 710 includes a drive circuit (DR) 711, a light source (LS) 712, and a collimator lens 713.

The drive circuit 711 controls the operation of the light source 712. The light source 712 includes a low-pressure or high-pressure mercury lamp or mercury xenon lamp, for example, and outputs light containing a wavelength component in the ultraviolet region and a wavelength component in the visible region.

The collimator lens 713 forms a parallel beam by transmitting the light outputted from the light source 712.

The wafer support table 721 is a heater with electrostatic chuck, for example, and fixes and keeps the wafer 100 at a predetermined temperature. In the wafer support table 721, an optical path channel 70 for allowing the light outputted from the light source unit 710 to enter the wafer 100 and guiding the reflection light from the wafer 100 to the light receiving unit 730 is formed.

The position adjustment mechanism includes support members 722 to 724. The support member 722 couple the light source unit 710 to the light receiving unit 730, and the support members 723 and 724 couples the support member 722 to the wafer support table 721. These support members 722 to 724 are desirably formed by a material having a small coefficient of thermal expansion such as inver, synthetic quartz, ZERODUR (registered trademark), quartz glass, or low-expansion polycrystalline glass. Thereby, the variation in optical path due to change of the relative positional relationship among the light source unit 710 and so on by the influence of heat can be suppressed.

Position adjustment parts 722a, 722b, 723a and 724a are provided in the coupling portions of the respective support members 722 to 724. The relative position of the light source unit 710, the light receiving unit 730, and the wafer support table 721 is adjusted by mechanically adjusting the position adjustment parts 722a, 722b, 723a and 724a based on the detection result of the position detection unit 760, which will be described later.

The light receiving unit 730 includes a group of wavelength separation filters 731, polarizing prisms 732 and 733, plural diffusers 734, plural lenses 735 and photodetectors 736 to 739.

The group of wavelength separation filters 731 contains three wavelength separation filters 71 to 73 having the same property. Each of the wavelength separation filters 71 to 73 transmits wavelength component λ_{UV}, totally reflects wavelength component λ₁, and functions as a half mirror for wavelength component λ₂. In the group of wavelength separation filters 731, the wavelength component λ_{UV} contained in the reflection light from the wafer 100 is transmitted through the wavelength separation filters 71 and 73 and guided toward the polarizing prism 732. Further, the wavelength component λ₁ is reflected by the wavelength separation filters 71 and 72 and guided toward the polarizing prism 733. Furthermore, the wavelength component λ₃ is transmitted through the wavelength separation filter 71, reflected by the wavelength separation filter 73, and guided toward the position detection unit 760.

Here, generally, the wavelength separation filter has polarization dependence, and thus, when it simply reflects or transmits light, the polarization state (ratio of P-polarized component and the S-polarized component) changes in the light after reflection or transmission. Accordingly, in the embodiment, the change in polarization state is prevented based on the following principle by positioning the wavelength separation filter 71 and the wavelength separation filter 72 such that they form 90° relative to each other with an optical axis as a rotational axis and the wavelength separation filter 71 and the wavelength separation filter 73 such that they form 90° relative to each other with an optical axis as a rotational axis.

Given that the reflectance of the P-polarized component is R_{P} and the reflectance of the S-polarized component is R_{S} in the wavelength separation filter 71 for the P-polarized and S-polarized lights reflected by the wafer 100, in the wavelength separation filter 72 rotated at 90° relative to it, the reflectance of the P-polarized component R_{P}′ and the reflectance of the S-polarized component R_{S}′ are represented as R_{P}′=R_{S} and R_{S}′=R_{P}.

Further, given that the intensity of the P-polarized component is I_{P} and the intensity of the S-polarized component is I_{S} of the light incident to the wavelength separation filter 71, the intensity of those polarized components changes to I_{P}×R_{P} (P-polarized component) and I_{S}×R_{S} (S-polarized component) after the light is reflected by the wavelength separation filter 71. When the lights are further reflected by the wavelength separation filter 72, the intensity of the respective polarized components in the light after reflection changes as follows.

P-polarized component: I_{P}×R_{P}×R_{P}′=I_{P}×R_{P}×R_{S}

S-polarized component: I_{S}×R_{S}×R_{S}′=I_{S}×R_{S}×R_{P}

Consequently, the ratio of the P-polarized component to the S-polarized component does not change before incidence to the wavelength separation filter 71 and after transmission through the wavelength separation filter 72.

Further, given that the transmittance of the P-polarized component is T_{P} and the transmittance of the S-polarized component is T_{S} in the wavelength separation filter 71, in the wavelength separation filter 73 rotated at 90° relative to it, the transmittance of the P-polarized component T_{P}′ and the transmittance of the S-polarized component T_{S}′ are represented as T_{P}′=T_{S} and T_{S}′=T_{P}. Therefore, the light transmitted through the wavelength separation filters 71 and 73 changes as follows.

P-polarized component: I_{P}×T_{P}×T_{P}′=I_{P}×T_{P}×T_{S}

S-polarized component: I_{S}×T_{S}×T_{S}′=I_{S}×T_{S}×T_{P}

Consequently, the ratio of the P-polarized component and the S-polarized component does not change before incidence to the wavelength separation filter 71 and after transmission through the wavelength separation filter 73.

Furthermore, the wavelength separation filters 71 to 73 are placed closely under the thermally same environment and the polarization dependences thereof are made equal, and thereby, the change in polarization state is effectively suppressed.

The polarizing prism 732 splits the ultraviolet light (wavelength component λ_{UV}) separated by the group of wavelength separation filters 731 according to the polarization direction, guides the P-polarized component λ_{UVP} toward the photodetector 736 and guides the S-polarized component λ_{UVS} toward the photodetector 737. Further, the polarizing prism 733 separates the visible light (wavelength component λ₁) separated by the group of wavelength separation filters 731 according to the polarization direction, guides the P-polarized component λ_{1P} toward the photodetector 738, and guides the S-polarized component λ_{1S} toward the photodetector 739.

The diffuser 734 is a ground glass or fly-eye lens, for example. The diffuser 734 and the lens 735 disposed at the downstream thereof are provided for uniformizing the intensity on the light application surface. Thereby, when the light enters the photodetectors 736 to 739, the error caused by the variation in optical axis is minimized. By the way, when the distances between the diffuser 734 and the photodetectors 736 to 739 are long, the same effect can be obtained without the lens 735.

The photodetectors 736 to 739 output a detection signal representing the P-polarized component λ_{UVP} of the ultraviolet light, a detection signal representing the S-polarized component λ_{UVS} of the ultraviolet light, a detection signal representing the P-polarized component λ_{1P} of the visible light, and a detection signal representing the S-polarized component λ_{1S} of the visible light, respectively. These detection signals are inputted to the signal processing unit 150 via the signal amplifier 140 and used for calculating the temperature of the wafer 100. The calculation method of the wafer temperature is the same as that explained in the fifth embodiment.

These photodetectors 736 to 739 are positioned such that the optical path lengths from the wavelength separation filter 71 are equal. Thereby, even when the variation is caused in the optical axis of the light entering the light receiving unit 730, the influence becomes equal among the photodetectors 736 to 739, and the occurrence of errors can be suppressed by cancelling the influence by the variation in the detection signals respectively outputted from the photodetectors 736 to 739.

The position detection unit 760 includes a condenser lens 761 and a position sensitive device (PSD) 762. The condenser lens 761 collects the light (wavelength component λ₂) transmitted through the wavelength separation filter 71 of the light receiving unit 730 and reflected by the wavelength separation filter 72 and guides it to the position sensitive device 762. The position sensitive device 762 detects the position of the received light, generates a detection signal, and outputs it to the signal processing unit 150. The signal processing unit 150 detects position variation and angle variation of the light applied to the wafer 100 based on the detection signal, and operates the position adjustment parts 722a, 722b, 723a, and 724a to perform alignment.

The position detection unit 760 may be arranged detachably from the light receiving unit 730 and attached only for use when alignment is performed.

As described above, in the embodiment, alignment is performed utilizing part of the light reflected by the wafer 100, and thereby, the light can be applied in a suitable position of the wafer 100 at a suitable angle. Also in the fifth and sixth embodiments of the present invention, alignment may be performed by adding an optical system that branches part of the received light to the light receiving unit, and providing the position detection unit as that in the embodiment.

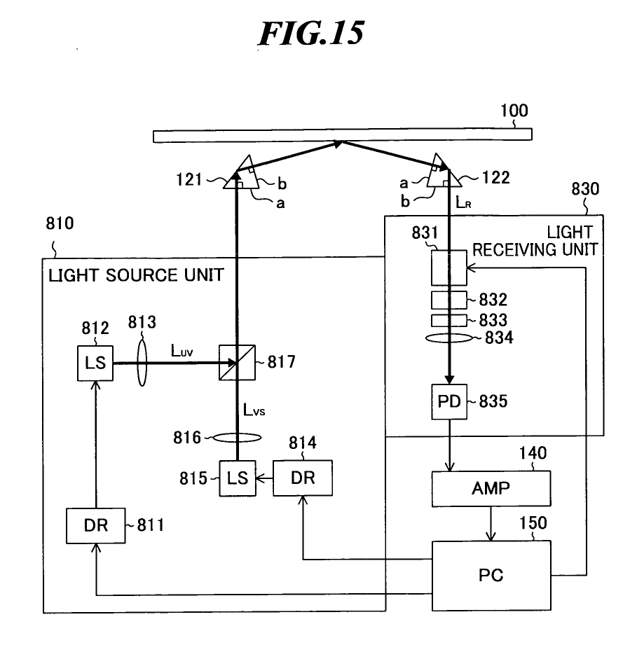

Next, a wafer temperature measuring apparatus according to the eighth embodiment of the present invention will be explained. FIG. 15 is a schematic diagram showing a configuration of the wafer temperature measuring apparatus according to the embodiment. In the embodiment, the apparatus is characterized in that plural kinds of detection signals are acquired by one photodetector in a time-sharing mode.

As shown in FIG. 15, the wafer temperature measuring apparatus according to the embodiment includes a light source unit 810, the prisms 121 and 122, a light receiving unit 830, the signal amplifier 140 and the signal processing unit 150. The configuration and operation of the prisms 121 and 122, the signal amplifier 140 and the signal processing unit 150 are the same as those in the wafer temperature measuring apparatus shown in FIG. 12.

The light source unit 810 includes drive circuits (DR) 811 and 814, light sources (LS) 812 and 815, collimator lenses 813 and 816 and a polarizing prism 817.

The drive circuits 811 and 814 control the operation of the light sources 812 and 815, respectively. Further, the operation of the drive circuits 811 and 814 are controlled to alternately operate in a time-sharing mode by the signal processing unit 150.

The light source 812 is a laser diode (LD) that generates ultraviolet light L_{UV} having a wavelength near 365 nm, for example, and positioned such that the light outputted therefrom enters the polarizing prism 817 in a P-polarized state.

The light source 815 is a laser diode that generates visible light L_{VS} having a wavelength near 650 nm, for example, and positioned such that the light outputted therefrom enters the polarizing prism 817 in an S-polarized state.

The collimator lenses 813 and 816 form parallel beams by transmitting the lights outputted from the light sources 812 and 815, respectively.

The polarizing prism 817 reflects or transmits incident light according to the polarization direction. In the embodiment, a prism that reflects a P-polarized component and transmits an S-polarized component is used. Thereby, the ultraviolet light L_{UV} outputted from the light source 812 is reflected by the polarizing prism 817 and guided to the prism 121, and the visible light L_{VS} outputted from the light source 815 is transmitted through the polarizing prism 817 and guided to the prism 121. Further, the polarization state entering the polarizing prism 817 is only the P-polarized component or only the S-polarized component, and thereby, even when a change in environment such as a temperature occurs in the polarizing prism 817, the change in the polarization state of the light reflected or transmitted by the polarizing prism 817 (the ratio of the P-polarized component to the S-polarized component) can be prevented.

Further, the polarizing prism 817 is positioned such that the ratio of the P-polarized component to the S-polarized component to the wafer 100 becomes about 1:1 in the light entering the wafer 100 via the prism 121.

The polarizing prism has a tolerance to environmental changes and an advantage in prolonged stability compared to a wavelength selection filter formed by a multilayer film. Further, a Wollaston prism may be used in place of the polarizing prism 817.

The light receiving unit 830 includes a light modulator 831, a polarizer 832, a diffuser 833, a lens 834, and a photodetector (PD) 835.

The light modulator 831 is formed by a Pockels cell, for example, and changes the polarization state of light transmitted through it according to an electrical signal to be supplied. Here, the Pockels cell is an optical element utilizing the EO (electro-optic) effect that the refractive index and anisotropy of a crystal change when an electric field is applied to the crystal. By controlling the electric field applied to the Pockels cell, the plane of polarization of light transmitted through it can be rotated to a predetermined angle (e.g., 90°). Such operation of the light modulator 831 is controlled by the signal processing unit 150.

Alternatively, the light modulator 831 may be arranged with a drive mechanism that mechanically rotates elements such as a wave plate with an optical axis as a rotational axis.

The polarizer 832 transmits a predetermined polarized component contained in the light transmitted through the light modulator 831 (P-polarized component in the embodiment).

The diffuser 833 is a ground glass or fly-eye lens, for example. The diffuser 833 and the lens 834 disposed at the downstream thereof are provided for uniformizing the intensity on the light application surface.

In the wafer temperature measuring apparatus, by alternately operating the drive circuits 811 and 814 of the light source unit 810, the ultraviolet light and visible light outputted from the light source unit 810 and reflected by the wafer 100 are alternately received by the light receiving unit 830.

Here, when the light modulator 831 is not activated, the reflection light (light L_{R}) from the wafer 100 is not changed in polarization direction and transmitted through the light modulator 831. Thereby, the P-polarized component contained in the light L_{R} is transmitted through the polarizer 832. On the other hand, when the light modulator 831 is activated, the polarization direction of the light L_{R} is rotated to 90° by the light modulator 831. Thereby, the P-polarized component in the rotated polarization direction (i.e., S-polarized component contained in the light L_{R}) is transmitted through the polarizer 832. Thus, by switching the activation state of the light modulator 831, the P-polarized component and the S-polarized component contained in the light L_{R} are alternately detected by the photodetector 835 via the diffuser 833 and lens 834.

Therefore, by synthesizing the operation timing of the drive circuits 811 and 814 with the activation timing of the light modulator 831, a detection signal representing the P-polarized component of the ultraviolet light L_{UV}, a detection signal representing the S-polarized component of the ultraviolet light L_{UV}, a detection signal representing the P-polarized component of the visible light L_{VS}, and a detection signal representing the S-polarized component of the visible light L_{VS} are sequentially inputted to the signal processing unit 150 via the signal amplifier 140. The calculation method of the wafer temperature is the same as that explained in the fifth embodiment.

Thus, according to the embodiment, four kinds of detection signals can be acquired by one photodetector, and thereby, the apparatus can be downsized by reducing the number of devices. Further, the loss of light can be reduced and the temperature can be efficiently measured. Further, the optical paths after the reflection by the wafer 100 before the detection by the photodetector 835 are the same in all light components, and the variation in optical path and the error caused by the non-uniformity of the sensitivity in the photodetector can be minimized.

In the embodiment, as is the case of the seventh embodiment of the present invention, alignment may be performed utilizing part of the light reflected by the wafer 100.

When the temperature of the wafer is measured using the above-explained wafer temperature measuring apparatus according to the embodiment of the present invention, calibrated parameters required in the equations used for calculating the temperature must be obtained in advance. Further, it is desirable that these parameters are altered in response to the changes in property of optical elements or the like. For the purpose, a method of calibrating and altering parameters will be explained as below.

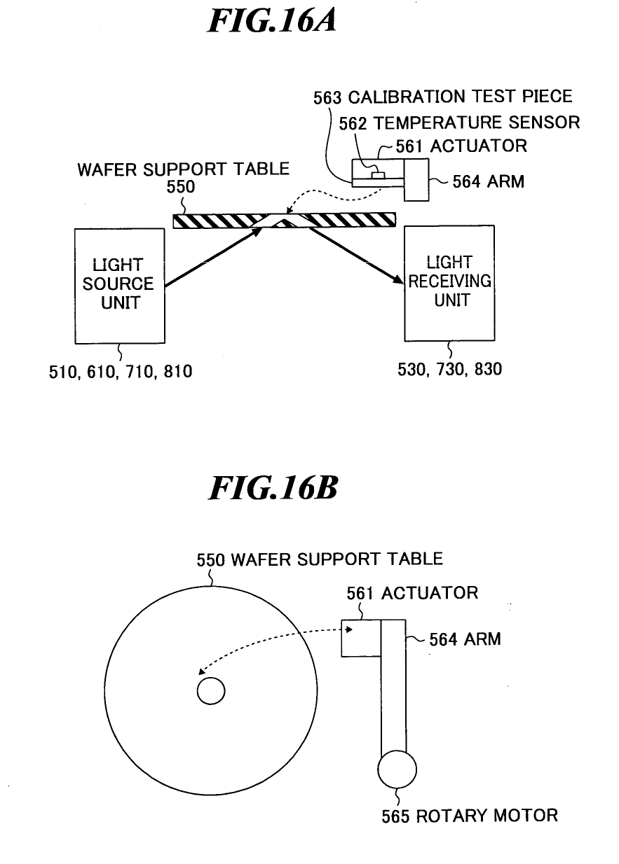

FIGS. 16A and 16B are diagrams for explanation of a method of calibrating and altering parameters in the wafer temperature measuring apparatus according to the embodiments. FIG. 16A is a sectional view showing part of the front of the wafer temperature measuring apparatus, and FIG. 16B is a plan view thereof.

When calibration and alteration of parameters are performed in the wafer temperature measuring apparatus, first, a calibration test piece 563 of a wafer having plural thicknesses or the like with a temperature sensor 562 of a resistance thermometer or the like mounted thereon is prepared, and this is attached to an arm 564 that is rotatable by a rotary motor 565 via an actuator 561 that moves vertically. The temperature sensor 562 may be mounted near the calibration test piece 563.

Then, the calibration test piece 563 is provided on a wafer support table 550, and, while the temperature is sensed by the temperature sensor 562 is observed, the calibration test piece 563 is left as it reaches to a thermal equilibrium state. When it is confirmed that the calibration test piece 563 reaches to the thermal equilibrium state, light is applied to the calibration test piece 563 by the light source unit 510, 610, 710, or 810, and the temperature is measured based on the output signals of the photodetectors contained in the light receiving unit 530, 730, or 830.

Furthermore, while the temperature of the calibration test piece 563 is changed by temperature adjustment, the temperature is measured based on the output signals of the photodetectors in the same manner as above at each temperature. Thereby, plural kinds of measurement data based on the output signals of the photodetectors in plural thicknesses and plural temperatures can be obtained. Based on thus obtained plural kinds of measurement data, calibration of parameters required in the equations used for calculating a temperature can be performed using the least square method.

Further, since the ratios of the P-polarized components to the S-polarized components in ultraviolet light and visible light change due to the variations in optical axes and deterioration in properties in optical elements, the temperature characteristics and deterioration of properties of photodetectors, temperature dependence of electrical circuits, and so on, when initially determined parameters are used, errors occur in the temperature measurement values. Therefore, parameters are desirably altered by regularly repeating the above-mentioned calibration method and part thereof. For example, parameters may be altered by measuring the temperature based on the output signals of the photodetectors with respect to the calibration test piece 563 having one kind of thickness.

Furthermore, in the fifth, sixth, and eighth embodiments, in the light receiving unit 530 or 830, between ultraviolet light and visible light or infrared light, optical elements for detecting reflection light, photodetectors, and electrical circuits are the same. When the output of the photodetectors by visible light or infrared light in the wafer having the same thickness as that of the calibration test piece 563 that has been used for calibrating parameters is measured, calibration of parameters is possible if the sensing of a temperature using the temperature sensor 562 is omitted.

Then, another method of calibrating parameters in the wafer temperature measuring apparatuses according to the fifth and eighth embodiments of the present invention will be explained. A wafer coated with a stable material (e.g., gold, silver, or the like) having reflectance that is not so much changed depending on temperature, or a wafer formed by such a stable material is measured at the same time when measurement for calibrating parameters is performed for the first time. Then, by regularly measuring the wafer, the temperature changes from the time of parameter calibration are known, and calibration of parameters becomes possible.

Thus, when the stable material that is not so much changed depending on temperature is used, the ratios of the P-polarized components to the S-polarized components in ultraviolet light and visible light are not so much changed depending on temperature, and the measurement values of a temperature that have been required in the previous calibration method becomes unnecessary, and the operation time can be reduced.

When such calibration or alteration is performed, measurement may be regularly performed by mixing calibration test pieces in wafers to be processed in semiconductor manufacturing processes. Alternatively, calibration test pieces are prepared separately from the wafers to be processed and measurement may be performed by regularly setting the calibration test pieces in the apparatus in place of the wafers to be processed. Furthermore, a mechanism for setting calibration test pieces on the wafer support table may be provided within the apparatus in advance. In this case, the wafer to be processed and the calibration test piece are not necessarily in the same dimensions.

As described above, according to the fifth to eighth embodiments, the temperature of a target of temperature measurement is calculated based on the ratio of the reflection intensity of the P-polarized component of ultraviolet light that heavily depends on temperature to the reflection intensity of the other components (i.e., S-polarized component of ultraviolet light and the P-polarized component and the S-polarized component of visible light) that does not so much depends on temperature, and thereby, the influence by the oxide film formed on the surface of the target of temperature measurement or the like can be cancelled. Therefore, correct temperature measurement with reduced errors can be performed with respect to each kind of wafers regardless of the surface condition of a wafer as a target of temperature measurement, i.e., the thickness and property of an oxide film.

Next, a wafer temperature measuring apparatus according to the ninth embodiment of the present invention will be explained. The wafer temperature measuring apparatus according to the embodiment is for measuring a wafer temperature with accuracy in situ even in a low temperature process regardless of the surface condition of the target of temperature measurement (e.g., even in the case where an oxide film is formed on a silicon wafer).

As described above, the inventors of the present invention have found that, when the oxide film is formed on the surface of a target of temperature measurement (wafer), reflection on the surface of the oxide film and multiple reflection between the oxide film surface and the silicon surface occur, and thereby, the detected reflection intensity greatly changes due to interference of light. Accordingly, there is a possibility that the absolute value of a temperature becomes imprecise.

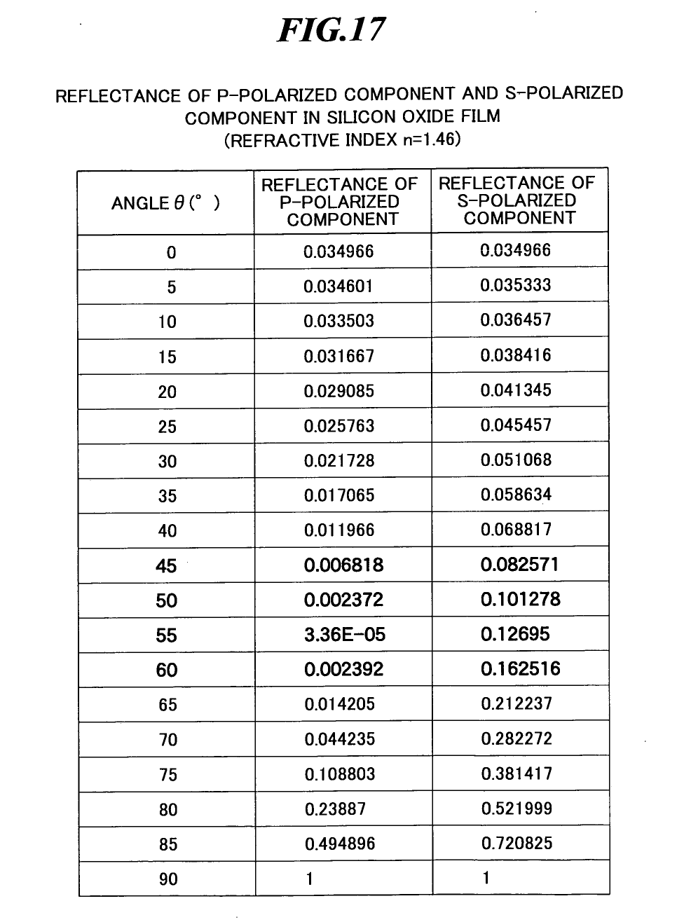

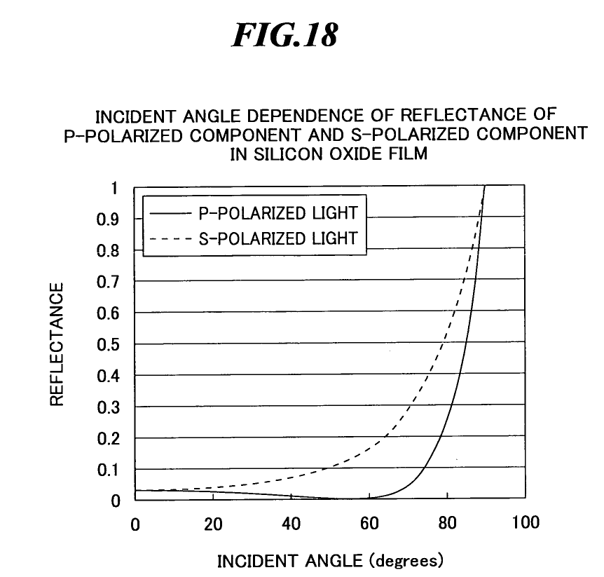

FIG. 17 is a table showing reflectance of the P-polarized component and the S-polarized component to a silicon oxide film, which is obtained by simulation assuming that the refractive index of the silicon oxide film is n=1.46 and the wavelength of incident light is 365 nm. Further, FIG. 18 is a graph showing incident angle dependence of the reflectance of the P-polarized component and the S-polarized component to the silicon oxide film, and created based on FIG. 17.

Generally, when light is incident upon a boundary face between two media having different reflectances from each other, there is an incident angle at which the reflectance of a component having an electrical vector contained in an incident plane (a plane containing the normal of the reflection surface and the traveling direction of light) (i.e., P-polarized component) becomes zero. Such an angle is called Brewster's angle. From FIGS. 17 and 18, in the silicon oxide film having refractive index about n=1.46, it seems that an angle near 55° at which the reflectance of the P-polarized component becomes extremely low is Brewster's angle. Further, the reflectance of the P-polarized component also becomes significantly lower within a predetermined range (e.g., 40°<θ<65° where Δθ is less than 25°, or desirably 45°≦θ≦60° where Δθ is 15°) containing Brewster's angle than in other ranges.

Accordingly, in order to calculated the temperature of the target of measurement, the inventors of the present invention made a study on application of P-polarized component of ultraviolet light that is sensitive to the temperature change of target of measurement to the target of measurement such that the incident angle becomes near Brewster's angle (within a predetermined range containing Brewster's angle). This is because the reflection intensity only from the target of measurement can be detected by suppressing the reflection from the surface of the oxide film or between the target of measurement and the oxide film.

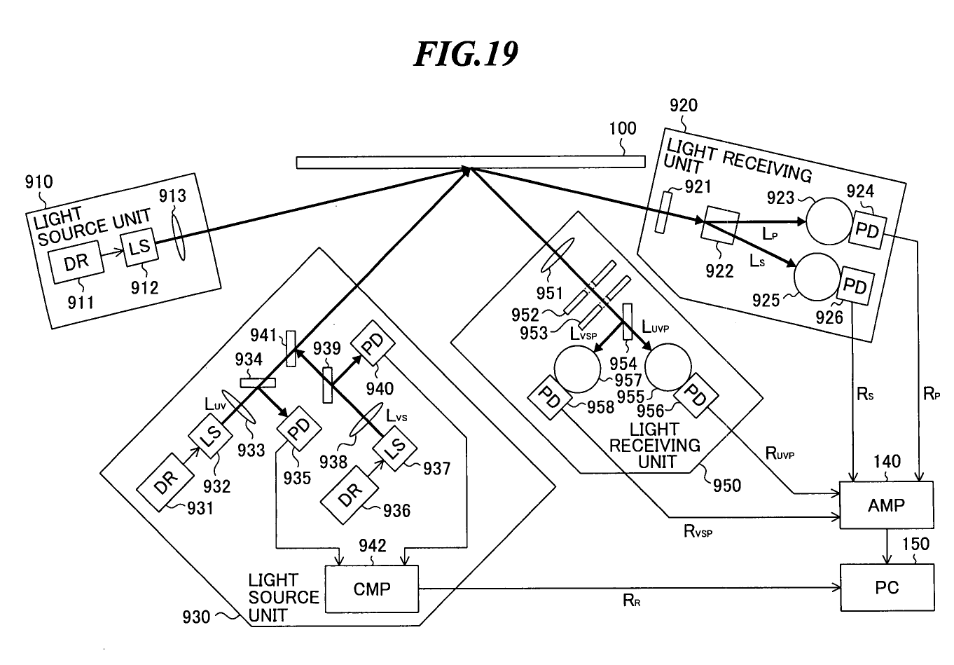

FIG. 19 is a schematic diagram showing a configuration of the wafer temperature measuring apparatus according to the ninth embodiment. As shown in FIG. 19, the wafer temperature measuring apparatus according to the embodiment includes a first optical system containing a light source unit 910 and a light receiving unit 920, a second optical system containing a light source unit 930 and a light receiving unit 950, the signal amplifier 140 and the signal processing unit 150. The device configuration of the signal amplifier 140 and the signal processing unit 150 is the same as that in the wafer temperature measuring apparatus shown in FIG. 4.

In the first optical system, the positions and angles of the light source unit 910, the wafer 100, and the light receiving unit 920 are adjusted such that light outputted from the light source unit 910 enters the wafer 100 at the incident angle larger than Brewster's angle (desirably, at the incident angle larger than substantially 60° and equal to or smaller than substantially 85°), and the reflection light thereof is received by the light receiving unit 920. On the other hand, in the second optical system, the positions and angles of the light source unit 930, the wafer 100, and the light receiving unit 950 are adjusted such that light outputted from the light source unit 930 enters the wafer 100 at the incident angle near Brewster's angle (e.g., from substantially 45° to substantially 60°), and the reflection light thereof is received by the light receiving unit 950.

In the embodiment, these optical systems are provided for the following reason. As described above, the second optical system is provided because it is necessary to allow the P-polarized component to enter the wafer 100 nearly at Brewster's angle for removing the influence of the oxide film formed on the surface of the wafer 100. However, as the incident angle becomes smaller, the difference in reflectance between the P-polarized component and the S-polarized component becomes smaller, and thus, not such high measurement accuracy can be obtained in the second optical system. Accordingly, in the embodiment, the first optical system that applies light at the incident angle larger than Brewster's angle is further provided, and the temperature of the wafer 100 is correctly obtained from the precise change in a wafer temperature measured by the first optical system and the absolute value of the temperature measured by the second optical system.

When the incident angle is too large, the anticipated width of the wafer 100 exceeds the beam width of the incident light, and vignetting (a phenomenon that unintended shadows appear) occurs. Therefore, the upper limit value of the incident angle in the first optical system is provided for avoiding the phenomenon. In the embodiment, the incident angle in the first optical system is set larger than substantially 60° and equal to or smaller than substantially 85° in a practical range, and desirably, larger than substantially 60° and equal to or smaller than substantially 75°.

The light source unit 910 includes a drive circuit (DR) 911, a light source (LS) 912, and a collimator lens 913. The drive circuit 911 controls the operation of the light source 912. Further, the light source 912 is a light emitting diode (LED) that emits ultraviolet light having a wavelength near 365 nm, for example. Furthermore, the collimator lens 913 forms a parallel beam by transmitting the ultraviolet light outputted from the light source 912.

By operating the light source unit 910, ultraviolet light containing the P-polarized component and the S-polarized component is applied to the wafer 100.

As the light source 912, a light source that outputs linearly-polarized light such as a laser diode may be used. In the case, in order to make the intensity of the P-polarized component and the S-polarized component nearly equal in the reflection light from the wafer 100, the position and the angle of the light source are adjusted such that the ratio of the P-polarized component to the S-polarized component desirably becomes about 3:1 in the incident light to the wafer 100.

The light receiving unit 920 includes a wavelength selection filter 921, a polarization beam splitter 922, integrating spheres 923 and 925, and photodetectors 924 and 926. The wavelength selection filter 921 transmits a predetermined wavelength component and reduces mixing of disturbance light in the light to be detected. Further, the polarization beam splitter 922 splits the entering light according to the polarization direction, guides the P-polarized component L_{P} of the light toward the photodetector 924, and guides the S-polarized component L_{S} toward the photodetector 926.

The photodetectors 924 and 926 are provided at the ports for detectors of the integrating spheres 923 and 925, and the lights entering the integrating spheres are guided to the detection surfaces of the photodetectors 924 and 926 regardless of orientation at the time of incidence. The influence by the variation in optical path between the P-polarized component L_{P} and the S-polarized component L_{S} after branched by the polarization beam splitter 922 can be minimized by the integrating spheres 923 and 925.

The photodetectors 924 and 926 include photoelectric conversion elements such as photodiodes (PD), for example. An electrical signal generated by the photodetector 924 is outputted as detection signal R_{P} representing the intensity of the P-polarized component L_{P}. Further, an electrical signal generated by the photodetector 926 is outputted as detection signal (reference signal) R_{S} representing the intensity of the S-polarized component L_{S}.

The light source unit 930 includes drive circuits (DR) 931 and 936, light sources (LS) 932 and 937, collimator lenses 933 and 938, beam splitters 934 and 939, photodetectors (PD) 935 and 940, a wavelength combining element (wavelength combining filter) 941, and a light quantity comparison part (CMP) 942. The drive circuits 931 and 936 control the operation of the light sources 932 and 937, respectively.

The light source 932 is a laser diode (LD) that generates ultraviolet light having a wavelength near 365 nm, for example. Further, the linear collimator lens 933 forms a parallel beam by transmitting ultraviolet light L_{UV} outputted from the light source 932. Furthermore, the beam splitter 943 transmits and guides part of incident light toward the wavelength combining element 941, and reflects and guides the rest of the incident light toward the photodetector 935. The photodetector 935 generates an electrical signal according to the intensity of the incident light.

On the other hand, the light source 937 is a laser diode that generates visible light having a wavelength near 650 nm. Further, the collimator lens 938 forms a parallel beam by transmitting the visible light L_{VS} outputted from the light source 937. Furthermore, the beam splitter 939 transmits and guides part of incident light toward the wavelength combining element 941, and reflects and guides the rest of the incident light toward the photodetector 940. The photodetector 940 outputs an electrical signal according to the intensity of the incident light.

The wavelength combining element (e.g., dichroic mirror) 941 transmits the ultraviolet light L_{UV} propagated from the direction of the light source 932 and reflects the visible light L_{VS} propagated from the direction of the light source 937. Thereby, the ultraviolet light L_{UV} and the visible light L_{VS} are combined and outputted from the light source unit 930.

The light quantity comparison part 942 obtains a ratio of intensity (a ratio of light quantities) of the outputted ultraviolet light L_{UV} and visible light L_{VS} based on the detection signals outputted from the photodetectors 935 and 940. The signal representing the ratio of light quantities obtained by the light quantity comparison part 942 is amplified and converted into a digital signal, and then, outputted as a correction signal R_{R} to the signal processing unit 150, which will be described later.

In the light source unit 930, the positions and the angles of the respective optical systems are adjusted such that the lights outputted from the light sources 932 and 937 enter the wavelength combining element 941 only in the P-polarized state or only in the S-polarized state. When a change in environment such as a temperature occurs in the wavelength combining element 941, the polarization state of the light reflected or transmitted by the wavelength combining element 941 (the ratio of the P-polarized component to the S-polarized component) is affected. However, when only one of the P-polarized or S-polarized component enters, the polarization state is not changed. Further, the position and the angle of the light source unit 930 are adjusted such that the light outputted therefrom enters the wafer 100 in the P-polarized state.

The light receiving unit 950 includes a lens 951, apertures 952 and 953, a wavelength separating element 954, integrating spheres 955 and 957, and photodetectors (PD) 956 and 958. The lens 951 suppresses the spread of the reflection light from the wafer 100. The apertures 952 and 953 are provided for removing unwanted disturbance light.

The wavelength separating element (e.g., dichroic mirror) 954 transmits and guides the ultraviolet light L_{UVP} contained in reflection light from the wafer 100 toward the photodetector 956 and reflects and guides the visible light L_{VSP} toward the photodetector 958. The position and the angle of the wavelength separating element 954 are adjusted such that, in order to prevent the change in polarization state of the light transmitted or reflected by the wavelength separating element 954, the reflection light from the wafer 100 enters only in the P-polarized state or only in the S-polarized state.

The photodetector 956 receives the light via the integrating sphere 955 and outputs detection signal R_{UVP} representing the intensity of the P-polarized component of ultraviolet light. Further, the photodetector 958 receives the light via the integrating sphere 957 and outputs detection signal R_{VSP} (reference signal) representing the intensity of the P-polarized component L_{VSP} of visible light.

Then, specific examples of the methods of calculating a wafer temperature in the signal processing unit 150 will be explained.

First, the signal processing unit 150 calculates temperature T₁ based on the detection signal R_{P} and the reference signal R_{S} outputted from the light receiving unit 920, and further, calculates temperature T₂ based on the detection signal R_{UVP} and the reference signal R_{VSP} outputted from the light receiving unit 950.

To obtain the temperature T₁, first, the relative value R₁ of the detection signal R_{P} to the reference signal R_{S} is obtained. The relative value R₁ may be the simple ratio R_{P}/R_{S} of the detection signal R_{P} to the reference signal R_{S}, or the ratio (R_{P}−α)/(R_{S}−α) after removing offsets. Further, the relative value may be obtained by using a suitable function. For example, R₁=(aR_{P}²+bR_{P}+c)/(aR_{S}²+bR_{S}+c) may be used.

Then, the temperature T₁ is calculated by using a predetermine function f(R₁) with the relative value R₁ as a variable and previously calibrated parameters. The function T₁=f(R₁) is a polynomial or multidimensional expression such as f(R₁)=aR₁+b or f(R₁)=aR₁²+bR₁+c. The function f(R₁) and parameters a, b, . . . may be obtained by detecting detection light and reference light while measuring the temperature of a test wafer by a contact method, for example, and performing computation (e.g., regression analysis or the like) using actual measurement values of the temperature and the detection signal R_{P} and the reference signal R_{S} in the temperature measuring apparatus shown in FIG. 19.

Alternatively, temperature T₁ may be directly calculated using function f′(R_{P}, R_{S}) with the detection signal R_{P} and the reference signal R_{S} as variables instead of using the relative value R₁. The function f′(R_{P}, R_{S}) and parameters thereof are obtained using the actual measurement values of the temperature obtained by the contact method as is the case of the function f(R₁).

On the other hand, regarding the temperature T₂, first, proper detection signal R_{UVP}′ and proper reference signal R_{VSP}′ are obtained by correcting the detection signal R_{UVP} and the reference signal R_{VSP} based on the correction signal R_{R}. In the light source unit 930 shown in FIG. 19, such correction is required because the two light sources 932 and 937 are used. Therefore, when only one wideband light source is used in which the ratio of intensity of wavelength components does not vary, this correction may not be required.

Then, relative value R₂ of the proper detection signal R_{UVP}′ and proper reference signal R_{VSP}′ is obtained, and the temperature T₂ is calculated in the same manner as the calculation method of the temperature T₁ by using function g(R₂) and previously calibrated parameters. Also, the function g(R₂) may be obtained by the temperature measurement by using a test wafer and computation (e.g., regression analysis or the like). Alternatively, the temperature T₂ may be calculated by using function g′(R_{UVP}′, R_{VSP}′) with the proper detection signal and proper reference signal as variables.

Then, the difference between the temperature T₁ and the temperature T₂, that is, ΔT=T₂−T₁ is calculated, and the parameters of the function f(R₁) are calibrated based on the difference ΔT. Specifically, the parameters of the function f(R₁) are changed such that the error ΔT approaches zero.

Using thus obtained calibrated parameters and function f(R₁) and the detection signal R_{P} and the reference signal R_{S} obtained by the first optical system, the temperature of the wafer 100 with reduced errors due to the surface oxide film can be obtained.

In the above ninth embodiment of the present invention, the measurement accuracy can be further improved using the respective average values of plural detection signals R_{UVP} and plural reference signals R_{VSP} obtained by operating the second optical system at plural times as the temperature T₂ used when the error ΔT is obtained.

Further, the calibration of the parameters of the function f(R₁) using the second optical system may be regularly performed, or may be performed at each time when the wafer as a target of temperature measurement is replaced. In the latter case, the operation of the second optical system may be automatically controlled based on the wafer replacement signal supplied from the outside of the wafer temperature measuring apparatus according to the embodiment.

Furthermore, in the embodiment, the S-polarized component of ultraviolet light is used as reference light in the first optical system, however, the other component may be used as long as its reflection intensity is not so much dependent on the temperature of the measurement target. For example, the P-polarized component or S-polarized component of visible light may be used.

As described above, according to the ninth embodiment of the present invention, since the P-polarized component of ultraviolet light having reflection intensity that is largely dependent on the temperature of the measurement target is applied to the measurement target such that the incident angle becomes near Brewster's angle and the temperature of the measurement target is calculated based on the reflection intensity of the reflection light, correct temperature measurement with reduced errors due to the surface condition of the wafer as the target of temperature measurement, i.e., the thickness and property of the oxide film.

1. A method of measuring a wafer temperature based on reflected light of light applied to a wafer as a target of temperature measurement, said method comprising the steps of:
(a) generating light containing a P-polarized component having a wavelength not larger than 400 nm and applying the light to a target of temperature measurement;
(b) receiving the light reflected by said target of temperature measurement and detecting at least intensity of the P-polarized component having the wavelength not larger than 400 nm contained in the reflected light; and
(c) calculating a temperature of said target of temperature measurement at least based on the intensity of the P-polarized component having the wavelength not larger than 400 nm detected at step (b).

2. The method according to claim 1, wherein:
step (a) includes generating light containing one of (i) an S-polarized component having a wavelength not larger than 400 nm, (ii) a P-polarized component having a wavelength larger than 400 nm, and (iii) an S-polarized component having a wavelength larger than 400 nm, together with the P-polarized component having the wavelength not larger than 400 nm, and applying the light to said target of temperature measurement;
step (b) includes detecting intensity of one of (i) the S-polarized component having the wavelength not larger than 400 nm, (ii) the P-polarized component having the wavelength larger than 400 nm, and (iii) the S-polarized component having the wavelength larger than 400 nm; and
step (c) includes calculating the temperature of said target of temperature measurement by using as a detection value the intensity of the P-polarized component having the wavelength not larger than 400 nm and using as a reference value the intensity of one of (i) the S-polarized component having the wavelength not larger than 400 nm, (ii) the P-polarized component having the wavelength larger than 400 nm, and (iii) the S-polarized component having the wavelength larger than 400 nm.

3. A method of measuring a wafer temperature based on reflected light of light applied to a wafer as a target of temperature measurement, said method comprising the steps of:
(a) applying light containing a wavelength component having a wavelength not larger than 400 nm and a wavelength component having a wavelength larger than 400 nm to a target of temperature measurement;
(b) receiving light reflected by said target of temperature measurement and detecting (i) intensity of a P-polarized component having a wavelength not larger than 400 nm, (ii) intensity of a P-polarized component having a wavelength larger than 400 nm, and (iii) intensity of at least one of an S-polarized component having a wavelength not larger than 400 nm and an S-polarized component having a wavelength larger than 400 nm; and
(c) performing computation for correcting an error due to a coating formed on a surface of a wafer based on a relative value between the intensity of the P-polarized component having the wavelength not larger than 400 nm and the intensity of one of the S-polarized components and a relative value between the intensity of the P-polarized component having the wavelength larger than 400 nm and the intensity of one of the S-polarized components.

4. The method according to claim 3, wherein step (c) includes correcting the error based on a relative value between the intensity of the P-polarized component having the wavelength not larger than 400 nm and the intensity of the S-polarized component having the wavelength not larger than 400 nm and a relative value between the intensity of the P-polarized component having the wavelength larger than 400 nm and the intensity of the S-polarized component having the wavelength larger than 400 nm.

5. A method of measuring a wafer temperature based on reflected light of light applied to a wafer as a target of temperature measurement, said method comprising the steps of:
(a) applying light containing a wavelength component having a wavelength not larger than 400 nm and a wavelength component having a wavelength larger than 400 nm to a target of temperature measurement such that an incident angle thereof falls within a predetermined range containing Brewster's angle;
(b) receiving light reflected by said target of temperature measurement and detecting intensity of a P-polarized component having a wavelength not larger than 400 nm and intensity of a P-polarized component having a wavelength larger than 400 nm; and
(c) calculating a temperature of said target of temperature measurement based on the intensity of the P-polarized component having the wavelength not larger than 400 nm and the intensity of the P-polarized component having the wavelength larger than 400 nm detected at step (b).

6. The method according to claim 5, wherein step (a) includes applying the light containing the wavelength component having the wavelength not larger than 400 nm and the wavelength component having the wavelength larger than 400 nm to said target of temperature measurement such that the incident angle thereof falls within a range from 45° to 60°.

7. The method according to claim 5, further comprising the steps of:
(a2) applying light containing a P-polarized component having a wavelength not larger than 400 nm and one of (i) an S-polarized component having a wavelength not larger than 400 nm, (ii) a P-polarized component having a wavelength larger than 400 nm, and (iii) an S-polarized component having a wavelength larger than 400 nm to said target of temperature measurement such that an incident angle thereof becomes larger than Brewster's angle; and
(b2) receiving the light applied at step (a2) and reflected by said target of temperature measurement, and detecting intensity of the P-polarized component having the wavelength not larger than 400 nm and intensity of one of (i) the S-polarized component having the wavelength not larger than 400 nm, (ii) the P-polarized component having the wavelength larger than 400 nm, and (iii) the S-polarized component having the wavelength larger than 400 nm;
wherein step (c) includes calculating a wafer temperature based on the intensity of the P-polarized component having the wavelength not larger than 400 nm and the intensity of the P-polarized component having the wavelength larger than 400 nm detected at step (b) and the intensity of the P-polarized component having the wavelength not larger than 400 nm and the intensity of one of (i) the S-polarized component having the wavelength not larger than 400 nm, (ii) the P-polarized component having the wavelength larger than 400 nm, and (iii) the S-polarized component having the wavelength larger than 400 nm detected at step (b2).

8. The method according to claim 7, wherein step (a2) includes applying the light containing the P-polarized component having the wavelength not larger than 400 nm and one of (i) the S-polarized component having the wavelength not larger than 400 nm, (ii) the P-polarized component having the wavelength larger than 400 nm, and (iii) the S-polarized component having the wavelength larger than 400 nm to said target of temperature measurement such that the incident angle thereof becomes larger than 60°.

9. An apparatus for measuring a wafer temperature based on reflected light of light applied to a wafer as a target of temperature measurement, said apparatus comprising:
light applying means for generating light containing a P-polarized component having a wavelength not larger than 400 nm and applying the light to said target of temperature measurement;
light receiving means for receiving the light reflected by said target of temperature measurement and detecting at least intensity of the P-polarized component having the wavelength not larger than 400 nm contained in the reflected light; and
calculating means for calculating a temperature of said target of temperature measurement at least based on the intensity of the P-polarized component having the wavelength not larger than 400 nm detected by said light receiving means.

10. The apparatus according to claim 9, wherein:
said light applying means includes a light source for generating light having a wavelength not larger than 400 nm, and an optical system for guiding the light generated by said light source to said target of temperature measurement;
said light receiving means includes a polarizer for separating the received light into a P-polarized component and an S-polarized component, and first photodetecting means and second photodetecting means for respectively detecting intensity of the P-polarized component and the S-polarized component separated by said polarizer; and
said calculating means calculates the temperature of said target of temperature measurement by using the intensity of the P-polarized component detected by said first photodetecting means as a detection value and using the intensity of the S-polarized component detected by said second photodetecting means as a reference value.

11. The apparatus according to claim 9, wherein:
said light applying means includes a first light source for generating light having a wavelength not larger than 400 nm, a second light source for generating light having a wavelength larger than 400 nm, and an optical system for guiding a P-polarized component of the light generated by the first light source and one of a P-polarized component and an S-polarized component of the light generated by the second light source to said target of temperature measurement;
said light receiving means includes light separating means for separating the received light according to one of a wavelength and a polarization direction thereof, and first photodetecting means and second photodetecting means for respectively detecting intensity of the P-polarized component having the wavelength not larger than 400 nm and one of the P-polarized component and the S-polarized component having a wavelength larger than 400 nm separated by said light separating means; and
said calculating means calculates the temperature of said target of temperature measurement by using the intensity of the P-polarized component having the wavelength not larger than 400 nm detected by said first photodetecting means as a detection value and using the intensity of one of the P-polarized component and the S-polarized component having the wavelength larger than 400 nm detected by said second photodetecting means as a reference value.

12. The apparatus according to claim 9, wherein:
said light applying means includes a light source for generating light having a wavelength not larger than 400 nm, and an optical system for guiding the light generated by said light source to said target of temperature measurement;
said light receiving means includes light modulating means for changing a polarization direction of the received light at a predetermined time interval, a polarizer for transmitting a predetermined polarized component, and photodetecting means for receiving the light via said light modulating means and said polarizer and detecting intensity of the P-polarized component and an S-polarized component contained in the light reflected by said target of temperature measurement in a time-sharing mode; and
said calculating means calculates the temperature of said target of temperature measurement by using the intensity of the P-polarized component detected by said photodetecting means as a detection value and the intensity of the S-polarized component detected by said photodetecting means as a reference value.

13. An apparatus for measuring a wafer temperature based on reflected light of light applied to a wafer as a target of temperature measurement, said apparatus comprising:
light applying means for applying light containing a wavelength component having a wavelength not larger than 400 nm and a wavelength component having a wavelength larger than 400 nm to a target of temperature measurement;
light receiving means for receiving the light reflected by said target of temperature measurement and detecting (i) intensity of a P-polarized component having a wavelength not larger than 400 nm, (ii) intensity of a P-polarized component having a wavelength larger than 400 nm, and (iii) intensity of at least one of an S-polarized component having a wavelength not larger than 400 nm and an S-polarized component having a wavelength larger than 400 nm; and
calculating means for performing computation for correcting an error due to a coating formed on a surface of a wafer based on a relative value between the intensity of the P-polarized component having the wavelength not larger than 400 nm and the intensity of one of the S-polarized components and a relative value between the intensity of the P-polarized component having the wavelength larger than 400 nm and the intensity of one of the S-polarized components.

14. The apparatus according to claim 13, wherein:
said light applying means includes a first light source and a second light source for respectively generating light having a wavelength not larger than 400 nm and light having a wavelength larger than 400 nm in a time-sharing mode;
said light receiving means includes separating means for separating the received light into a P-polarized component and an S-polarized component, first photodetecting means and second photodetecting means for respectively detecting intensity of the P-polarized component and the S-polarized component separated by said separating means; and
said calculating means performs computation based on (i) the intensity of the P-polarized component having the wavelength not larger than 400 nm detected by the first photodetecting means in a time-sharing mode, (ii) the intensity of the P-polarized component having the wavelength larger than 400 nm detected by the first photodetecting means in the time-sharing mode, and (iii) at least one of the intensity of the S-polarized component having the wavelength not larger than 400 nm and the intensity of the S-polarized component having the wavelength larger than 400 nm detected by the second photodetecting means in a time-sharing mode.

15. The apparatus according to claim 13, wherein:
said light applying means includes a light source for generating light containing the wavelength component having the wavelength not larger than 400 nm and the wavelength component having the wavelength larger than 400 nm;
said light receiving means includes first separating means for separating the received light into the wavelength component having the wavelength not larger than 400 nm and the wavelength component having the wavelength larger than 400 nm, plural second separating means for separating each of the wavelength component having the wavelength not larger than 400 nm and the wavelength component having the wavelength larger than 400 nm separated by said first separating means into a P-polarized component and an S-polarized component, and plural photodetecting means for respectively detecting intensity of the plural components separated by said plural second separating means; and
said calculating means performs computation based on (i) the intensity of the P-polarized components having the wavelength not larger than 400 nm, (ii) the intensity of the P-polarized components having the wavelength larger than 400 nm, and (iii) at least one of the intensity of the S-polarized component having the wavelength not larger than 400 nm and the intensity of the S-polarized component having the wavelength larger than 400 nm respectively detected by said plural photodetecting means.

16. The apparatus according to claim 13, wherein:
said light applying means includes a first light source and a second light source for respectively generating light having a wavelength not larger than 400 nm and light having a wavelength larger than 400 nm in a time-sharing mode;
said light receiving means includes light modulating means for changing a polarization direction of the received light at a predetermined time interval, and a polarizer for transmitting a predetermined polarized component, and photodetecting means for receiving the light via said light modulating means and said polarizer and detecting intensity of a P-polarized component and an S-polarized component contained in the light reflected by said target of temperature measurement in a time-sharing mode; and
said calculating means performs computation based on (i) the intensity of the P-polarized component having the wavelength not larger than 400 nm, (ii) the intensity of the P-polarized component having the wavelength larger than 400 nm, and (iii) at least one of the intensity of the S-polarized component having the wavelength not larger than 400 nm and the intensity of the S-polarized component having the wavelength larger than 400 nm detected by the photodetecting means in the time-sharing mode.

17. An apparatus for measuring a wafer temperature based on reflected light of light applied to a wafer as a target of temperature measurement, said apparatus comprising:
light applying means for applying light containing a wavelength component having a wavelength not larger than 400 nm and a wavelength component having a wavelength larger than 400 nm to a target of temperature measurement such that an incident angle thereof falls within a predetermined range containing Brewster's angle;
light receiving means for receiving light reflected by said target of temperature measurement and detecting intensity of a P-polarized component having a wavelength not larger than 400 nm and intensity of a P-polarized component having a wavelength larger than 400 nm; and
calculating means for calculating a temperature of said target of temperature measurement based on the intensity of the P-polarized component having the wavelength not larger than 400 nm and the intensity of the P-polarized component having the wavelength larger than 400 nm detected by said light receiving means.

18. The apparatus according to claim 17, wherein said light applying means applies the light containing the wavelength component having the wavelength not larger than 400 nm and the wavelength component having the wavelength larger than 400 nm to said target of temperature measurement such that the incident angle thereof falls within a range from 45° to 60°.

19. The apparatus according to claim 17, further comprising:
second light applying means for applying light containing a P-polarized component having a wavelength not larger than 400 nm and one of (i) an S-polarized component having a wavelength not larger than 400 nm, (ii) a P-polarized component having a wavelength larger than 400 nm, and (iii) an S-polarized component having a wavelength larger than 400 nm to said target of temperature measurement such that an incident angle thereof becomes larger than Brewster's angle; and
second light receiving means for receiving the light applied by said second light applying means and reflected by said target of temperature measurement, and detecting intensity of the P-polarized component having the wavelength not larger than 400 nm and intensity of one of (i) the S-polarized component having the wavelength not larger than 400 nm, (ii) the P-polarized component having the wavelength larger than 400 nm, and (iii) the S-polarized component having the wavelength larger than 400 nm;
wherein said calculating means calculates a wafer temperature based on the intensity of the P-polarized component having the wavelength not larger than 400 nm and the intensity of the P-polarized component having the wavelength larger than 400 nm detected by said first light receiving means and the intensity of the P-polarized component having the wavelength not larger than 400 nm and the intensity of one of (i) the S-polarized component having the wavelength not larger than 400 nm, (ii) the P-polarized component having the wavelength larger than 400 nm, and (iii) the S-polarized component having the wavelength larger than 400 nm detected by said second light receiving means.

20. The apparatus according to claim 19, wherein said second light applying means applies the light containing the P-polarized component having the wavelength not larger than 400 nm and one of (i) the S-polarized component having the wavelength not larger than 400 nm, (ii) the P-polarized component having the wavelength larger than 400 nm, and (iii) the S-polarized component having the wavelength larger than 400 nm to said target of temperature measurement such that the incident angle thereof becomes larger than 60°.

21. The apparatus according to claim 9, wherein said light applying means includes:
a light source for emitting ultraviolet light;
a drive circuit for controlling operation of said light source;
a collimator lens for forming a parallel beam by transmitting the ultraviolet light emitted from said light source;
a beam splitter for splitting the parallel beam into two parts and guiding one part of the parallel beam to said target of temperature measurement;
an optical chopper for chopping the parallel beam guided to said target of temperature measurement by said beam splitter with predetermined timing or at a predetermined frequency; and
a photodetector for detecting the other part of the parallel beam split by said beam splitter.

22. The apparatus according to claim 9, wherein said light receiving means includes:
a wavelength selection filter for transmitting a predetermined wavelength component of an ultraviolet light reflected by said target of temperature measurement;
a polarization beam splitter for separating the ultraviolet light transmitted through said wavelength selection filter into a P-polarized component and an S-polarized component;
a first condenser lens for collecting the P-polarized component separated by said polarization beam splitter to a predetermined position;
a first photodetector for detecting the P-polarized component collected by said first condenser lens;
a second condenser lens for collecting the S-polarized component separated by said polarization beam splitter to another predetermined position; and
a second photodetector for detecting the S-polarized component collected by said first condenser lens.

23. The apparatus according to claim 9, further comprising:
a signal amplifier for amplifying at least a signal representing intensity of the P-polarized component having the wavelength not larger than 400 nm contained in the reflected light detected by said light receiving means;
wherein said calculating means calculates the temperature of said target of temperature measurement based on the signal amplified by said signal amplifier.

24. The apparatus according to claim 9, further comprising:
a first prism for guiding the light generated by said light applying means to said target of temperature measurement; and
a second prism for guiding the light reflected by said target of temperature measurement to said light receiving means.

25. The apparatus according to claim 13, wherein said light applying means includes:
a light source for emitting ultraviolet light;
a drive circuit for controlling operation of said light source;
a collimator lens for forming a parallel beam by transmitting the ultraviolet light emitted from said light source;
a beam splitter for splitting the parallel beam into two parts and guiding one part of the parallel beam to said target of temperature measurement;
an optical chopper for chopping the parallel beam guided to said target of temperature measurement by said beam splitter with predetermined timing or at a predetermined frequency; and
a photodetector for detecting the other part of the parallel beam split by said beam splitter.

26. The apparatus according to claim 13, wherein said light receiving means includes:
a wavelength selection filter for transmitting a predetermined wavelength component of an ultraviolet light reflected by said target of temperature measurement;
a polarization beam splitter for separating the ultraviolet light transmitted through said wavelength selection filter into a P-polarized component and an S-polarized component;
a first condenser lens for collecting the P-polarized component separated by said polarization beam splitter to a predetermined position;
a first photodetector for detecting the P-polarized component collected by said first condenser lens;
a second condenser lens for collecting the S-polarized component separated by said polarization beam splitter to another predetermined position; and
a second photodetector for detecting the S-polarized component collected by said first condenser lens.

27. The apparatus according to claim 13, further comprising:
a signal amplifier for amplifying at least a signal representing intensity of the P-polarized component having the wavelength not larger than 400 nm contained in the reflected light detected by said light receiving means;
wherein said calculating means calculates a temperature of said target of temperature measurement based on the signal amplified by said signal amplifier.

28. The apparatus according to claim 13, further comprising:
a first prism for guiding light generated by said light applying means to said target of temperature measurement; and
a second prism for guiding the light reflected by said target of temperature measurement to said light receiving means.

29. The apparatus according to claim 17, wherein said light applying means includes:
a light source for emitting ultraviolet light;
a drive circuit for controlling operation of said light source;
a collimator lens for forming a parallel beam by transmitting the ultraviolet light emitted from said light source;
a beam splitter for splitting the parallel beam into two parts and guiding one part of the parallel beam to said target of temperature measurement;
an optical chopper for chopping the parallel beam guided to said target of temperature measurement by said beam splitter with predetermined timing or at a predetermined frequency; and
a photodetector for detecting the other part of the parallel beam split by the said beam splitter.

30. The apparatus according to claim 17, wherein said light receiving means includes:
a wavelength selection filter for transmitting a predetermine wavelength component of an ultraviolet light reflected by said target of temperature measurement;
a polarization beam splitter for separating the ultraviolet light transmitted through said wavelength selection filter into a P-polarized component and an S-polarized component;
a first condenser lens for collecting the P-polarized component separated by said polarization beam splitter to a predetermined position;
a first photodetector for detecting the P-polarized component collected by said first condenser lens;
a second condenser lens for collecting the S-polarized component separated by said polarization beam splitter to another predetermined position; and
a second photodetector for detecting the S-polarized component collected by said first condenser lens.

31. The apparatus according to claim 17, further comprising:
a signal amplifier for amplifying at least a signal representing intensity the P-polarized component having the wavelength not larger than 400 nm contained in the reflected light detected by said light receiving means;
wherein said calculating means calculates a temperature of said target of temperature measurement based on the signal amplified by said signal amplifier.

32. The apparatus according to claim 17, further comprising:
a first prism for guiding the light generated by said light applying means to said target of temperature measurement; and
a second prism for guiding the light reflected by said target of temperature measurement to said light receiving means.
